(19) United States
(12) Patent Application Publication
(10) Pub. No.: US 2026/0316836 A1
(43) Pub. Date: Oct. 15, 2026

(54) VEHICLE FRAME SUBASSEMBLY

(71) Applicant: Re:Car Inc., Troy, MI (US)

(72) Inventors: Maaz Khan, Rochester Hills, MI (US); Hojjat Fathollahi, Troy, MI (US); Robert Raymor, Lake Orion, MI (US); Abhijit Mishra, Macomb, MI (US); Kamlesh Yadav, Irving, TX (US); Vladimir Loza, West Bloomfield, MI (US)

(21) Appl. No.: 19/644,416

(22) Filed: Apr. 10, 2026

Related U.S. Application Data
(60) Provisional application No. 63/786,920, filed on Apr. 10, 2025.

(51) Int. Cl. B62D 21/15

(52) U.S. Cl. CPC B62D 21/155

(57) ABSTRACT

A vehicle frame, a vehicle frame subassembly, and a vehicle comprising the same. The vehicle frame comprises longitudinal frame rails, a crossmember extending between and connected to the longitudinal frame rails, blockers connected to the longitudinal frame rails, and a cradle. The vehicle frame may perform in a small-offset frontal overlap impact and a full frontal impact.

### CROSS-REFERENCE TO RELATED APPLICATIONS

The present application claims benefit to U.S. Provisional Application No. 63/786,920, filed Apr. 10, 2025, which is incorporated herein by reference in its entirety.

### FIELD

The present teachings generally relate to vehicle frame subassemblies functioning in collision scenarios.

### BACKGROUND

Among the various collision safety ratings awarded to vehicles is the small overlap frontal collision performance, which replicates a scenario where a front corner of a vehicle collides with an object such as a tree, a utility pole, etc. Performance is rated based on intrusion(s) into the occupant compartment, injury risk determined from sensors in a dummy, and dummy movement. See Small Overlap Frontal Crashworthiness Evaluation Crash Test Protocol, Version VII, May 2021, Insurance Institute for Highway Safety (IIHS).

Generally, vehicles may exhibit a stacked crumple collision path or a Y-push collision path. In a stacked crumple collision path, the vehicle remains generally along its axial path of travel in a first stage and the rear end of the vehicle rotates outward in a second stage. In a Y-push collision path, the vehicle is pushed off transversely from a barrier, generally maintaining its orientation prior to the collision.

Among the various collision safety ratings awarded to vehicles is the full frontal collision performance, which replicates a scenario where a full front surface of a vehicle collides with an object such as a wall. Performance is rated based on intrusion(s) into the occupant compartment, injury risk determined from sensors in a dummy, and dummy movement. See New Car Assessment Program (NCAP) Full Frontal Rigid Barrier Impact Test Procedure – NHTSA-2015-0046-0014.

Another collision safety rating is a side impact, which replicates a scenario where the side of the occupant compartment is collided with an object such as another vehicle. See Side Impact Crashworthiness Evaluation 2.0 Crash Test Protocol, Version II, October 2022, Insurance Institute for Highway Safety (IIHS).

Electric vehicles can differ greatly in design philosophy for collision performance, compared to internal combustion engine vehicles, due to differences in overall weight, center of gravity, and powertrain component location.

There remains a need for vehicle frame subassemblies that performs with the highest ratings in at least the test procedures described above.

There remains a need for vehicle frame subassemblies that prevent or at least substantially mitigate intrusions of vehicle components into the occupant compartment.

There remains a need for vehicle frame subassemblies that prevent or at least substantially mitigate deformations of the occupant compartment that can interact with the body of an occupant to the effect of injury.

There remains a need for vehicle frame subassemblies that absorb the energy of a collision.

There remains a need for a vehicle frame that may be reconfigurable while maintaining desired collision performance.

### SUMMARY

The present disclosure relates to a vehicle frame subassembly for providing a controlled response in a small-offset frontal overlap impact, which may address at least some of the needs identified above. The vehicle frame subassembly may comprise a first longitudinal frame rail and a second longitudinal frame rail; a crossmember extending between and connecting the first and second longitudinal frame rails; and a first blocker and a second blocker respectively connected to the first and second longitudinal frame rails. The first and second blockers may be generally wedge-shaped and a corner thereof may be at least partially juxtaposed with the crossmember. The first and second blockers may function at least in part to direct energy toward a centerline of the vehicle, through the crossmember.

The vehicle frame subassembly may further comprise a first shock tower reinforcement, a second shock tower reinforcement, a first shotgun, and a second shotgun. The first and second shock tower reinforcements may connect, at first ends thereof, to the first and second longitudinal frame rails and, at second ends thereof, to the first and second shotguns. The first and second shock tower reinforcements may be respectively welded to the first and second longitudinal frame rails. The first and second longitudinal frame rails may be respectively welded to the first and second shotguns. The first and second shock tower reinforcements may function to support the first and second shotguns to transfer energy to the first and second shotguns and delay deformation of the first and second shotguns and accordingly aid the vehicle to glide along a barrier.

Each of the first and second shock tower reinforcements may comprise two transversely spaced apart flanges and one or more walls therebetween defining a generally polygonal cross-sectional profile, preferably a generally square or rectangular cross-sectional profile.

The first and second shotguns may include a plurality of stress concentrators in accordance with one or any combination of the following features: (A) each of the first and second shotguns may define a first side (e.g., a top side) and a second side (e.g., a bottom side) that are in opposing relationship to each other; (B) the plurality of stress concentrators may be located on the first and second sides; (C) the plurality of stress concentrators on the first side may correspond in quantity to the plurality of stress concentrators on the second side, and arranged spatially in pairs; (D) wherein each pair of the plurality of stress concentrators may be generally axially aligned; (E) each of the first and second sides may include 2 to 10 of the plurality of stress concentrators, more preferably 3 to 8, or even more preferably 4 to 6; or (F) the plurality of stress concentrators may extend partially between the first and second sides, preferably on an outboard region of the first and second shotguns.

The vehicle frame subassembly may further comprise a bumper beam, a first crush can, and a second crush can.

The first and second crush cans may be at least partially juxtaposed with the first and second longitudinal frame rails and at least partially juxtaposed with the first and second crush cans.

The first and second shotguns may be connected at first ends thereof, respectively, to the first and second crush cans, and at second ends thereof, respectively, to hinge pillars. The second ends have generally triangular shapes that flare out to contact the hinge pillars.

The first and second longitudinal frame rails may comprise a plurality of stress concentrators. The plurality of stress concentrators may be located on an inboard side of the first and second longitudinal frame rails and/or an outboard side of the first and second longitudinal frame rails. The plurality of stress concentrators may include first stress concentrators located on a top corner and/or a bottom corner of the first and second longitudinal frame rails, second stress concentrators that extend between the top and bottom corners, or both.

The first and second longitudinal frame rails may be oriented at an angle, with respect to the centerline of the vehicle. The angle may be about 1 degree to about 15 degrees. The longitudinal frame rails may be at their furthest distance from the centerline at the front-most ends thereof.

The crossmember may include two opposing ends which are respectfully connected to the first and second longitudinal frame rails.

further comprising first and second inserts located respectively within cavities of the first and second longitudinal frame rails; wherein the inserts are generally juxtaposed with the crossmember; and wherein the inserts facilitate energy transfer from the crossmember through opposing sides of the first and second longitudinal frame rails.

The first and second longitudinal frame rails may comprise two segments that are fastened together (e.g., via pinch welds). Seams between the two segments may extends along lengths of the first and second longitudinal frame rails.

The first and second shotguns may comprise two segments that are fastened together (e.g., via pinch welds). Seams between the two segments extends along lengths of the first and second shotguns.

The vehicle frame subassembly may further comprise a cradle comprising a first longitudinal segment located proximate to the first longitudinal frame rail, a second longitudinal segment located proximate to the second longitudinal frame rail, and one or more crossmembers extending between the first and second longitudinal segments. The one or more crossmembers may include three crossmembers. One or more of the crossmembers may be hourglass shaped.

The cradle may be located below the first and second longitudinal frame rails. The cradle may be connected to the first and second longitudinal frame rails. The cradle may comprise a first pair of attachment members and a second pair of attachment members. The first and second pair of attachment members may connect the cradle to the first and second longitudinal frame rails. Each of the first and second pairs of attachment members may be generally aligned transversely. The first pair of attachment members may be located in axial alignment with a first of the one or more crossmembers and the second pair of attachment members may be located in axial alignment or proximate to axial alignment with a second of the one or more crossmembers.

The first and second longitudinal frame rails may each include a wing on a rearward end thereof that bends respectively toward corners of hinge pillars, and which is connected to the hinge pillar.

The vehicle frame subassembly may further comprise a firewall comprising at least a top segment and a bottom segment. The first and second longitudinal frame rails may be connected to the bottom segment.

The vehicle frame subassembly may further comprise a first rocker and a second rocker. The first and second rockers may include an inner segment, an outer segment, and one or more reinforcement segments that include at least one bend. The first and second rockers may extend to first and second hinge pillars.

The vehicle frame subassembly may further comprise one or more first tension braces and one or more second tension braces respectively connecting the first and second longitudinal frame rails, first and second hinge pillars, first and second rockers, or any combination thereof. The first tension braces may connect the longitudinal frame rails, the hinge pillars, and the rockers. The second tension braces may connect the first tension braces and the rockers.

The vehicle frame subassembly may further comprise first and second hinge pillar reinforcements. The first and second hinge pillar reinforcements may locate on inboard sides, respectively, of the first and second hinge pillars.

The vehicle frame subassembly may further comprise a floor reinforcement. The floor reinforcement may extend into a region defined between the first and second hinge pillars.

The vehicle frame subassembly may further comprise a tunnel reinforcement that locates over a tunnel in a floor pan.

The vehicle frame subassembly may further comprise first and second floor boxes respectively connecting the first and second longitudinal frame rails, first and second rockers, a floor pan, or any combination thereof.

Cooperation of at least the first or second longitudinal frame rail, the crossmember, the first or second blocker, the first or second shock tower reinforcement, and the first or second shotgun, the cradle, or any combination thereof during the small-offset frontal overlap impact, may result in said controlled response and a pre-determined sequence of deformation. The pre-determined sequence of deformation may include: deformation of the bumper beam and the first or second crush can; pivoting of the first or second blocker resulting in formation of at least a first bend in the first or second longitudinal frame rail, and a transverse energy transfer imposed upon the crossmember; transfer of energy transversely through the cradle and deformation thereof; detachment of one or more attachment members of the cradle from one or both of the first or second longitudinal frame rails; transfer of energy along a length of the first or second shotgun and deformation of the first or second shotgun, at an end connected to the first or second blocker, toward the centerline of the vehicle; transfer of energy through the first or second shock tower reinforcement to the first or second shotgun; a second bend in the first or second longitudinal frame rail, the first and second bends defining a Z-shape in the first or second longitudinal frame rail; or any combination thereof.

At least two events in the sequence of deformation may occur generally contemporaneously (+/- 10 milliseconds).

Deformation of the first or second longitudinal frame rails and the cradle may occur generally contemporaneously (+/- 10 milliseconds).

A vehicle may comprise the vehicle frame subassembly according to any one or combination of the preceding paragraphs. The vehicle may be an electric vehicle. The vehicle may be a reconfigurable vehicle, as described herein.

The vehicle frame subassembly, upon the small-offset frontal overlap impact, may move the vehicle in a Y-push path, relative to an object the vehicle collides with.

The present disclosure relates to a vehicle frame subassembly for providing a controlled response in a full frontal impact, which may address at least some of the needs identified above. The vehicle frame subassembly may comprise: a first longitudinal frame rail and a second longitudinal frame rail adapted and/or configured to buckle transversely at one or more predefined locations along their lengths; a cradle adapted and/or configured to buckle generally vertically at one or more predefined locations along its length; and a plurality of attachment members for joining the first and second longitudinal frame rails and the cradle prior to a collision, the cradle being positioned below the first and second longitudinal frame rails. The first and second longitudinal frame rails and the cradle may travel together for a first predetermined distance until one or more of the plurality of attachment members disconnect.

The first and second longitudinal frame rails may comprise a plurality of stress concentrators. The plurality of stress concentrators may include one or more first stress concentrators and one or more second stress concentrators. The plurality of stress concentrators may influence a Z-shaped deformation of the first and second longitudinal frame rails.

The plurality of stress concentrators may be located on an inboard side of the first and second longitudinal frame rails and/or an outboard side of the first and second longitudinal frame rails. The plurality of stress concentrators may include first stress concentrators located on a top corner and/or a bottom corner of the first and second longitudinal frame rails, second stress concentrators that extend between the top and bottom corners, or both.

The cradle may comprise a plurality of stress concentrators. The plurality of stress concentrators may include first stress concentrators located between attachment members. The plurality of stress concentrators may include second stress concentrators located along at least one crossmember of the cradle. The plurality of stress concentrators may influence a Z-shaped deformation of the cradle. The Z-shaped fold may be in a direction that is generally perpendicular to a plane in which the Z-shaped deformations of the first and second longitudinal frame rails are arranged. The Z-shaped deformation of the first and second longitudinal frame rails may be in a transverse direction and the Z-shaped deformation of the cradle is in a generally vertical direction.

The vehicle frame subassembly may further comprise a bumper beam, a first crush can, and a second crush can.

The first and second longitudinal frame rails may be at least partially juxtaposed respectively with the first and second crush cans.

The first and second longitudinal frame rails may be oriented at an angle, with respect to the centerline of the vehicle The angle may be about 1 degree to about 15 degrees. The longitudinal frame rails may be at their furthest distance from the centerline at the front-most ends thereof.

The first and second longitudinal frame rails may comprise two segments that are fastened together (e.g., via pinch welds). Seams between the two segments may extend along lengths of the first and second longitudinal frame rails.

The vehicle frame subassembly may further comprise a first shock tower reinforcement, a second shock tower reinforcement, a first shotgun, and a second shotgun. The first and second shock tower reinforcements may connect, at first ends thereof, to the first and second longitudinal frame rails and, at second ends thereof, to the first and second shotguns. The first and second shock tower reinforcements may be respectively welded to the first and second longitudinal frame rails. The first and second longitudinal frame rails may be respectively welded to the first and second shotguns. The first and second shock tower reinforcements may function to support the first and second shotguns to transfer energy to the first and second shotguns and delay deformation of the first and second shotguns.

the first and second shotguns include a plurality of stress concentrators in accordance with one or any combination of the following features: (A) wherein each of the first and second shotguns define a first side (e.g., a top side) and a second side (e.g., a bottom side) that are in opposing relationship to each other; (B) wherein the plurality of stress concentrators are located on the first and second sides; (C) wherein the plurality of stress concentrators on the first side correspond in quantity to the plurality of stress concentrators on the second side, and arranged spatially in pairs; (D) wherein each pair of the plurality of stress concentrators are generally axially aligned; (E) each of the first and second sides include 2 to 10 of the plurality of stress concentrators, more preferably 3 to 8, or even more preferably 4 to 6; or (F) the plurality of stress concentrators extend partially between the first and second sides, preferably on an outboard region of the first and second shotguns.

The vehicle frame subassembly may further comprise a first blocker and a second blocker respectively connected to the first and second frame rails. The first and second blockers may be at least partially juxtaposed, respectively, the first and second crush cans.

A vehicle may comprise the vehicle frame subassembly for providing a controlled response in a full frontal impact according to any one or combination of the preceding paragraphs. The vehicle may be an electric vehicle. The vehicle may be a reconfigurable vehicle, as described herein.

### BRIEF DESCRIPTIONS OF THE DRAWINGS

FIG. 1A is a top plan view of a vehicle frame.

FIG. 1B is a side plan view of a vehicle frame.

FIG. 1C is a perspective view of a vehicle frame.

FIG. 1D is a perspective view of a vehicle frame.

FIG. 1E is a rear plan view of a vehicle frame.

FIG. 1F is a sectional view of a vehicle frame.

FIG. 2A is a perspective view of a vehicle frame.

FIG. 2B is a perspective view of a vehicle frame.

FIG. 3 is a perspective view of a crush can.

FIG. 4 is a perspective view of a vehicle frame.

FIG. 5A is a plan view of a blocker.

FIG. 5B is a perspective view of a blocker.

FIG. 6A is a perspective view of a longitudinal frame rail.

FIG. 6B is a perspective view of a longitudinal frame rail.

FIG. 6C is an exploded view of a longitudinal frame rail.

FIG. 7A is a perspective of a shotgun.

FIG. 7B is a perspective view of a shotgun.

FIG. 7C is an exploded view of a shotgun.

FIG. 8 is a plan view of a vehicle frame.

FIG. 9A is a perspective view of a shock tower reinforcement.

FIG. 9B is a perspective view of a shock tower reinforcement.

FIG. 10 is a perspective view of a vehicle frame.

FIG. 11 is a perspective view of a tension brace.

FIG. 12A is a perspective view of a vehicle frame.

FIG. 12B is a perspective view of a vehicle frame.

FIG. 13A is a perspective view of a vehicle frame.

FIG. 13B is a perspective view of a hinge pillar reinforcement.

FIG. 14A is a plan view of a vehicle frame.

FIG. 14B is a plan view of a floor box.

FIG. 14C is a perspective view of a floor box.

FIG. 15A is a perspective view of a cradle and suspension assembly.

FIG. 15B is a perspective view of a cradle.

FIG. 15C is a plan view of a cradle.

FIG. 15D is a plan view of a cradle.

FIG. 16A is a plan view an impact sequence.

FIG. 16B is a plan view of an impact sequence.

FIG. 16C is a plan view of an impact sequence.

FIG. 16D is a plan view of an impact sequence.

FIG. 16E is a plan view of an impact sequence.

FIG. 16F is a plan view of an impact sequence.

FIG. 17A1 is a perspective view of an impact sequence.

FIG. 17A2 is a plan view of an impact sequence.

FIG. 17B1 is a perspective view of an impact sequence.

FIG. 17B2 is a plan view of an impact sequence.

FIG. 17C1 is a perspective view of an impact sequence.

FIG. 17C2 is a plan view of an impact sequence.

FIG. 17D1 is a perspective view of an impact sequence.

FIG. 17D2 is a plan view of an impact sequence.

FIG. 18A is a perspective view of an impact sequence.

FIG. 18B is a perspective view of an impact sequence.

### DETAILED DESCRIPTION

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

### Vehicle Frame

The vehicle disclosed herein may have a vehicle frame. Unless otherwise stated a “frame” of a vehicle herein refers generally to a vehicle portion, shell, or skeleton that imparts structural integrity to the vehicle, whether to the entire vehicle and/or a portion only of the vehicle. A frame typically is a part of the vehicle that provides support for one or more vehicle body panels, interior components, and/or a part of the vehicle to which other vehicular components can be attached. For example, one or more interior vehicle components (e.g., interior panels, vehicle seats, dashboard, etc.) of the vehicle may be attached or supported on the frame. For example, one or more exterior vehicle components (e.g., exterior panels, doors, lights, windows, etc.) of the vehicle may be attached or supported on the frame. A vehicle frame may include one or more (e.g., a pair of spaced apart longitudinally extending) frame rails that extend from a rear end portion of the vehicle at least partially along the length of the vehicle towards the front end of the vehicle. A frame may include one or a plurality of subassemblies. The subassemblies may be configured to absorb energy and a controlled impact response. For example, in the event of a small overlap frontal impact, a full frontal impact, a side impact, or any combination thereof.

The vehicle frame may include structural components such as, but not limited to, A-pillars, B-pillars, floor pan, cargo area walls, as well as any other structural components described herein. In some configurations, one or more elements of the vehicle frame may be permanently connected together such as via welding, riveting, bolting, and/or adhesive bonding. The vehicle frame or structural components of the vehicle frame may be made of a high strength architecture made of metal, aluminum, and/or steel. The frame may include a plurality of fastener elements (e.g., weld nuts, self-clinching nuts, blind rivet nuts, rivets or other threaded inserts) located at predefined locations and configured to receive another fastener element for attaching vehicle components (e.g., body panels, article carriers, or the like) to the frame.

The present disclosure refers to a vehicle frame and one or more vehicle frame subassemblies. To more fully understand the present teachings, it is understood that the vehicle frame may have one or more characteristics of some combination of a body-on-frame, a skateboard, and a unibody. That is, the design philosophy of the vehicle frame, and accordingly the vehicle frame subassemblies, may be mixed, providing unique challenges in impact performance, which may not have heretofore been realized.

The vehicle frame may comprise one or more vehicle frame subassemblies, which may also be referred to herein as subassemblies. One or more elements of a subassembly may be shared by elements of one or more other subassemblies, one or more elements of a subassembly may be discrete from one or more elements of another subassembly, or a combination of the foregoing may be the case. It is also contemplated that elements of the vehicle frame may function for different modes of collision. In this regard, reference to constituent elements of a subassembly is not intended to limit those elements to just one subassembly or just one collision mode. A subassembly may include elements that function to absorb energy, transfer forces, divert forces, or the like during a particular type of collision.

It is also contemplated that where reference to “the” or “an” element of the present teachings is made, the same may apply to a corresponding element on the other side of the vehicle.

The vehicle frame subassembly may comprise a bumper beam. The bumper beam may be the first element that contacts a barrier in a frontal collision. The bumper beam may be adapted to glide along a barrier in a small-offset frontal overlap impact. In this regard, the bumper beam may include one or more curvatures, one or more angles, or both, which influences said gliding action. Said one or more curvatures and/or one or more angles may be located outboard of crush cans described herein. Said one or more curvatures and/or one or more angles may be at least partially overlap with crush cans described herein.

The bumper beam may be connected to one or more crush cans, one or more brackets, or both. Preferably, two crush cans and two brackets. The one or more crush cans, one or more brackets, or both may include at least one located on a left side of the bumper beam and at least one located on a right side of the bumper beam.

The bumper beam may be fabricated from aluminum or steel.

In one exemplary aspect of the present teachings, the bumper beam may be fabricated from steel. The bumper beam may be connected to a crush can disposed on a left side thereof and a crush can disposed on a right side thereof. The bumper beam may be connected to a bracket disposed on a left side thereof and a bracket disposed on a right side thereof. The brackets may be connected to the crush cans. The bumper beam may have a central portion, an intermediate portion on either side thereof, and an end portion on either side thereof. The intermediate portion may be arranged at a first angle to the central portion. The end portion may be arranged at a second angle to the central portion, and at an angle to the intermediate portion. The crush cans may be connected to the central portion. The brackets may be connected to the intermediate portions.

In another exemplary aspect of the present teachings, the bumper beam may be fabricated from aluminum. The bumper beam may be connected to two crush cans disposed on a left side thereof and two crush cans disposed on a right side thereof. These may be referred to herein as dual crush cans. Each of the dual crush cans may have a monolithic construction. The bumper beam may have a central portion and an end portion on either side thereof. The end portions may be defined by a curvature. A portion of the dual crush cans may be connected to the central portion and a portion of the dual crush cans may be connected to the end portions.

The vehicle frame subassembly may comprise one or more crush cans. The one or more crush cans may be connected, at one end, to the bumper beam, and at an opposing end to one or more of: longitudinal frame rails, shotguns, and blockers. In this regard, energy is translated to these structural elements and through these structural elements in a manner described below.

The one or more crush cans may have a generally polygonal cross-sectional profile. The one or more crush cans may have a generally quadrilateral cross-sectional profile. The one or more crush cans may have one or more hollow regions, which may also be referred to as cavities.

The one or more crush cans may be in the form of dual crush cans. Dual crush cans may be defined by the juxtaposition of two crush cans. Dual crush cans may have two hollow regions that are separated by a wall. The dual crush cans may absorb more energy in deformation compared to a single crush can.

The crush cans may function in a frontal impact collision. The one or more crush cans may function to collapse and absorb energy by deformation.

The vehicle frame subassembly may comprise one or more blockers. The one or more blockers may function to transfer energy to a crossmember, to one or more longitudinal frame rails, to one or more shotguns, or any combination thereof. The one or more blockers may transfer energy from a first axis to a second axis. The second axis may be oriented about 75 degrees to about 105 degrees, more preferably about 80 degrees to about 100 degrees, more preferably about 85 degrees to about 95 degrees, or even more preferably about 90 degrees, relative to the first axis. The second axis may be arranged along the crossmember described herein. The one or more blockers may pivot. Pivoting of the one or more blockers may be effectuated in cooperation with bending of longitudinal frame rails, described herein. The one or more blockers may influence bending of the longitudinal frame rails.

The one or more blockers may be generally in the shape of a wedge. The one or more blockers may have a first side that engages the one or more crush cans, a second side that engages the longitudinal frame rail, and a third side that is arranged at an acute angle relative to the first and second sides. The one or more blockers may comprise one or more additional sides. The third side may be at least partially juxtaposed with a crossmember, an insert, or both, described below. An edge of the third side may be generally aligned with a central axis of the crossmember.

The one or more blockers may have one or more hollow regions. The one or more blockers may comprise one or more ribs, one or more brackets, or both. The one or more ribs, one or more brackets, or both may be located within the hollow region. By way of one example, a bracket may be disposed on the third side to stiffen the third side.

The one or more blockers may be fabricated from aluminum. The one or more blockers may be fabricated by extrusion. The extrusion may define outer walls of the one or more blockers, one or more ribs of the blockers, or both. The extrusion may defined outer walls and/or ribs that are about 4 millimeters to about 8 millimeters in thickness, about 5 millimeters to about 7 millimeters in thickness, or more preferably about 6 millimeters in thickness.

The one or more blockers may comprise one or more flanges. The one or more flanges may be located at edges of the first side, the second side, the third side, or any combination thereof. The flanges may mate with flanges of the longitudinal frame rails, flanges of the crush cans, or both. The one or more blockers may be connected to the longitudinal frame rails via one or more fasteners (e.g., bolts). The one or more fasteners may extend through the flanges of the one or more blockers.

The blockers may function in a frontal impact collision. The blockers may influence a Y-push of the vehicle in a small-offset frontal overlap impact collision. In this regard, the blockers may transfer forces through the crossmember described herein, transferring forces transversely across the vehicle frame. The blockers may at least partially influence bending of the longitudinal frame rails in a pre-determined manner.

The vehicle frame subassembly may comprise one or more crossmembers. The crossmember may function to carry energy generally transversely across the vehicle frame. As described herein, energy from a blocker may be transferred to the crossmember.

The crossmember may extend between longitudinal frame rails. The crossmember may contact, be connected to, or be supported by the longitudinal frame rails. The crossmember may be directly fastened to the longitudinal frame rails. The crossmember may be supported by brackets connected to the longitudinal frame rails. The crossmember may be juxtaposed with inserts located in the longitudinal frame rails. The inserts may provide continuous load transfer to or from the crossmember by bridging opposing sides of the longitudinal frame rails.

The crossmember may be monolithic in construction. The crossmember may be fabricated from two or more segments. The two or more segments may be fastened together (e.g., via welding, mechanical fasteners, chemical fastener, or any combination thereof).

The crossmember may comprise one or more longitudinal flanges. The one or more longitudinal flanges may be employed to fasten together opposing segments of the crossmember.

The crossmember may comprise one or more end flanges located on opposing ends of the crossmember. The one or more end flanges may function to engage with the longitudinal frame rails, the insert, or both.

The crossmember may comprise a hollow region. The hollow region may be defined by a tubular monolithic construction. The hollow region may be defined between a first segment and a second segment, and optionally one or more other segments. One or more reinforcing elements may be located in the hollow region. The one or more reinforcing elements may include one or more ribs, one or more brackets, a foam (e.g., an expandable structural foam), or any combination thereof.

The crossmember may have a polygonal (e.g., a quadrilateral) cross-sectional profile. The crossmember may have a radiused (e.g., circular) profile.

In one exemplary aspect, the crossmember may be of monolithic construction. The crossmember may be in the form of a tube with a hollow interior. The crossmember may be supported at the opposing ends thereof by brackets fastened to the longitudinal frame rails.

In one exemplary aspect, the crossmember may comprise at least a first segment and a second segment. The crossmember may optionally comprise one or more third segments. The one or more third segments may be respectively located at opposing ends of the first and/or second segment. The third segments may be at least partially overlapped by the first/second segment, or vice versa. The first segment, the second segment, the optional one or more third segments, or any combination thereof may comprise one or more flanges extending longitudinally along the crossmember and located on opposing sides thereof. The flanges may be placed into engagement to fasten the first segment, the second segment, and the optional one or more third segments. By way of example, but not limitation, the flanges may be placed into engagement and welded to fasten together the first segment, the second segment, and the optional one or more third segments. The crossmember may comprise end flanges at both opposing ends, for fastening to the longitudinal frame rails.

The crossmember may function in a frontal impact collision. The crossmember may cooperate with the blockers to influence a Y-push of the vehicle in a small-offset frontal overlap impact collision. In this regard, the blockers may transfer forces through the crossmember, longitudinal frame rail, insert in the longitudinal frame rail, or any combination thereof, transferring forces transversely across the vehicle frame.

The vehicle frame subassembly may comprise one or more longitudinal frame rails. The one or more longitudinal frame rails may extend from the bumper beam to the hinge pillar. The one or more longitudinal frame rails may be connected to the bumper beam, to the hinge pillar, or both (e.g., via welding, mechanical fasteners, chemical fastener, or any combination thereof).

The one or more longitudinal frame rails may comprise one or more segments, preferably two or more segments. The two or more segments may be connected. The two or more segments may be fastened together by, e.g., welding (e.g., pinch welds), mechanical fasteners, chemical fastener, or any combination thereof. The two or more segments may include one or more inner segments and one or more outer segments; or one or more upper segments and one or more lower segments. The two or more segments may include flanges on opposing ends thereof. The two or more segments may be connected at the flanges thereof. Seams between the two or more segments may extend along the length of the longitudinal frame rails.

The one or more segments may define a hollow region therebetween. The hollow region, or at least a substantial part of the hollow region, and the walls defining it may be generally polygonal in shape, e.g., rectangular. One or more reinforcing elements may be located in the hollow region. The one or more reinforcing elements may include one or more ribs, one or more brackets, a foam (e.g., an expandable structural foam), one or more inserts, or any combination thereof.

The first and second longitudinal frame rails may define a cross-sectional profile, viewed along a longitudinal axis thereof. The aspect ratio may be about 1:3 to about 3:1, more preferably about 1:2 to 2:1, or even more preferably about 1.5:1 to 1:1.5.

The one or more longitudinal frame rails may comprise one or more stress concentrators. The one or more stress concentrators may be located on an inner segment and/or an outer segment. Preferably the one or more stress concentrators may be located on an inner segment and an outer segment. The one or more stress concentrators may include two stress concentrators on an inner segment that extend transversely along a side thereof. The one or more stress concentrator may include two stress concentrators on an inner segment that are located on opposing corners of the inner segment, and which are in alignment on a transverse axis. The one or more stress concentrators may include two or more stress concentrators on an outer segment. The two or more stress concentrators may include four or more or even six or more stress concentrators. The two or more stress concentrators may be located on opposing corners of the outer segment. Pairs of stress concentrators may be aligned on a transverse axis. The two or more stress concentrators of the outer segment may be approximately juxtaposed with one or more of the stress concentrators of the inner segment.

The one or more longitudinal frame rails may comprise a wing. The wing may bend toward a corner of a hinge pillar. The wing may be fastened to the hinge pillar. The wing may have a largest dimension that is greater than the largest dimension of the end of the longitudinal frame rail from which the wing extends. In this regard, the wing may have a larger area for fastening to the hinge pillar and for force transfer.

First and second longitudinal frame rails may be oriented at an angle, with respect to the centerline of the vehicle. The angle may be about 1 degree to about 15 degrees, about 2 degrees to about 13 degrees, 4 degrees to about 11 degrees, or even 6 degrees to about 9 degrees. The longitudinal frame rails may be at their furthest distance from the centerline at the front-most ends thereof.

The one or more longitudinal frame rails may be fabricated from Dual Phase (DP) 590 steel, HSLA 550 steel, HSLA 340, HSLA 330 steel, or any combination thereof. Preferably, the one or more longitudinal frame rails may be fabricated from HSLA 550 steel.

The longitudinal frame rail may function in a frontal impact collision. The longitudinal frame rail may deform in a pre-determined manner. The longitudinal frame rail may bend in at least two regions. The longitudinal frame rail may have a Z-shaped deformation. The pre-determined deformation may be influenced by the stress concentrators, pivoting of the blocker, action of the shock tower reinforcement, action of the crossmember, connection of the hinge pillar, or any combination thereof. The shock tower reinforcement discussed herein may be connected to the longitudinal frame rail in a region between the two bends in a Z-shaped deformation. In a full frontal impact, the longitudinal frame rail may deform to absorb energy from a collision. The cradle described herein may cooperate with the longitudinal frame rail in this regard. In a small-offset frontal overlap impact, the longitudinal frame rail may deform to transfer forces across the crossmember and through the shock tower reinforcement. Forces diverted through the crossmember transfer a significant amount of energy transversely across the vehicle and to mitigate said energy propagating toward the occupant compartment. Forces diverted through the shock tower reinforcement may brace the shotgun in the region of the shock tower reinforcement and prevent or at least substantially mitigate deformation of the shotgun proximate to the hinge pillar.

The vehicle frame subassembly may comprise a cradle. The cradle may be located below the longitudinal frame rails. The cradle may be connected to the longitudinal frame rails. The cradle may be fastened to the longitudinal frame rails by welding, mechanical fasteners, chemical fastener, or any combination thereof. The cradle may be connected to the floor pan. The cradle may be fastened to the floor pan by welding, mechanical fasteners, chemical fastener, or any combination thereof. One or more connections of the cradle may be broken in a pre-determined manner during a collision. Breaking of the connections may absorb energy.

The cradle may comprise two segments oriented generally longitudinally. The cradle may comprise two or more crossmembers extending between and connected at the ends thereof to the two segments. The one or more crossmembers may have a rod shape, an hourglass shape, or both. A front-most crossmember may have a rod shape. One or more crossmembers rearward of the front-most crossmember may have an hourglass shape. The flared portions of the hourglass shape may provide for a broader area of force transfer to a longitudinal segment. A front end of the cradle may have a width that is greater than a rear end of the cradle.

The cradle may comprise one or more stress concentrators. The one or more stress concentrators may be located on one or both, preferably both, of the longitudinal segments. Stress concentrators may be arranged in one or more pairs of stress concentrators that are aligned transversely across the cradle. The one or more stress concentrators may be located on a top surface of the cradle, a bottom surface of the cradle, or both. The one or more stress concentrators may influence one or more bends in the cradle during a collision.

The cradle may comprise one or more attachment members that connect the cradle to the longitudinal frame rails. The one or more attachment members may extend upward from a top surface of the cradle. The one or more attachment members may be in the form of posts. The one or more attachment members may be fastened to the longitudinal frame members by welding, mechanical fasteners, chemical fastener, or any combination thereof. One or more of the attachment members may separate from the longitudinal frame rails during a collision.

The cradle may comprise two or more forward attachment members and two or more rearward attachment members. The forward attachment members may be generally transversely aligned. The rearward attachment members may be generally transversely aligned.

The cradle may function in a frontal impact collision. The cradle may bend to absorb energy in a frontal impact collision. The cradle may bend along at least one transverse axis, more preferably along at least two transverse axes. The cradle may bend in a V-shape or a Z-shape, preferably a Z-shape. The attachment members may detach from the longitudinal frame rails by influence of said bending. Such detachment may absorb energy in a frontal impact collision. In a small-offset frontal overlap impact collision, forces may be transferred transversely along the one or more crossmembers, thus diverting energy away from the region of the collision and cooperating to influence a Y-push as described herein and/or mitigate intrusion into the occupant compartment. The structure of the cradle described herein balances function and performance for a full frontal rigid barrier impact collision and a small-offset frontal overlap impact collision.

The vehicle frame subassembly may comprise one or more shotguns. The one or more shotguns may extend from a front of the vehicle frame to a hinge pillar. The one or more shotguns may have a radiused portion and a generally linear portion. The radiused portion may extend from the front of the vehicle. In one exemplary arrangement, the radiused portion may be connected to and extend from a blocker described herein. The generally linear portion may connect to a hinge pillar. The one or more shotguns may extend along an outboard side of the vehicle frame subassembly.

The first and second shotguns may comprise a first portion that is angled relative to the centerline of the vehicle and a second portion that is generally parallel (+/- 5 degrees) with the centerline. The first portion may be forward of the second portion. The radiused portion described above may include at least a part of the first portion. The generally linear portion described above may include at least a part of the second portion. The angle of the first portion, relative to the centerline is about 15 to about 30 degrees, more preferably about 18 to about 26 degrees, or even more preferably about 20 to about 22 degrees. The angle of the first portion may aid the vehicle in gliding along an object in a collision.

The one or more shotguns may be connected to an end of a longitudinal frame rail, a crush can, a blocker, or any combination thereof. The one or more shotguns may be connected to a hinge pillar. The one or more shotguns may be fastened to one or more of the foregoing elements by welding, mechanical fasteners, chemical fastener, or any combination thereof.

The one or more shotguns may comprise one or more segments. The one or more segments may be connected. The one or more segments may be fastened together by, e.g., welding, mechanical fasteners, chemical fastener, or any combination thereof. The one or more segments may include one or more inner segments and one or more outer segments; or one or more upper segments and one or more lower segments. The one or more segments may include flanges on opposing ends thereof. The one or more segments may be connected at the flanges thereof. The one or more segments may define a hollow region therebetween.

One or more reinforcing elements may be located in the hollow region. The one or more reinforcing elements may include one or more ribs, one or more brackets, one or more inserts, a foam (e.g., an expandable structural foam), or any combination thereof.

In one preferable aspect, the one or more segments may include an inner segment and an outer segment, each comprising flanges on opposing sides thereof and extending substantially the length of the shotgun. One set of flanges may be oriented in an upward direction and the other set of flanges may be oriented in a downward direction.

The one or more shotguns may comprise one or more stress concentrators. Stress concentrators, as discussed herein, may mean any structure that provides for a pre-determined deformation of the element on which they are located. The stress concentrators may be in the form of grooves or bosses in a surface, a region of thinner material at least partially surrounded by thicker material, cutouts, or the like. The grooves or bosses may have a wedge or radiused shape. The present teachings are not intended to be limited to the foregoing and any other form of stress concentrator generally known may be employed.

The one or more stress concentrators may be located on an inner segment and/or an outer segment. Preferably the one or more stress concentrators may be located on an outer segment. The one or more stress concentrators may be located proximate to a shock tower and a shock tower reinforcement. The one or more stress concentrators may be located on an upper surface of the shotgun, on a lower surface of the shotgun, or both. Preferably, the one or more stress concentrators are located on an upper and lower surface of the shotgun, and the upper and lower stress concentrators may be generally aligned. One or more stress concentrators may be located on a radiused portion of the one or more shotguns, on a generally linear portion of the one or more shotguns, or both. The one or more stress concentrators may include about 4 to 12 stress concentrators, more preferably about 6 to 10 stress concentrators, or even more preferably about 8 stress concentrators.

The shotgun may have a triangular shape in the region of its connection to the hinge pillar. In this regard, the shotgun flares out toward the hinge pillar and a greater area of connection to the hinge pillar may be achieved. Thus, forces can be better distributed relative to the hinge pillar. For example, through the hinge pillar and up through an A-pillar, through the hinge pillar and down through the rocker, or both. The triangular region may include one or more segments, two or more segments, or even three or more segments. Preferably, the triangular region may be one segment.

The one or more longitudinal frame rails may be fabricated from Dual Phase (DP) 590 steel, HSLA 550 steel, HSLA 340, HSLA 330 steel, or any combination thereof. Preferably, the one or more longitudinal frame rails may be fabricated from Dual Phase (DP) 590 steel.

The shotgun may function in a frontal impact collision. The shotgun may be particularly advantageous in a small-offset frontal overlap impact. The shotgun begins to deform early in a collision, owing to its connection in the region of the crush can, end of the longitudinal frame rail, and blocker. By the pivoting action of the blocker, the front end of the shotgun is influenced to deform by curling inwards, toward a centerline of the vehicle frame. This deformation may be at least partially counteracted in the region of the shock tower reinforcement, which may transfer forces to the shotgun from the longitudinal frame rail. Thus, in the region of the shock tower the shotgun may be braced and ultimately, a region of the shotgun proximate to a hinge pillar may be prevented or at least substantially mitigated. As a result, a Y-push path of the vehicle may be achieved. In this regard, the barrier may slide and glance off of the shotgun. Thus, intrusion of the barrier and/or vehicle frame elements into the occupant compartment can be avoided or at least substantially avoided.

In a full frontal impact, the shotgun may contribute to collision performance by absorbing energy from the collision and propagating forces rearward to the hinge pillar. It has been observed that deformation of the shotgun in and beyond the region of the shock tower reinforcement the shotgun may substantially maintain its shape.

The vehicle frame subassembly may comprise one or more shock tower reinforcements. The one or more shock tower reinforcement may be connected at a first end to a longitudinal frame rail and at a second end to a shotgun. The one or more shock tower reinforcements may span a gap between a longitudinal frame rail and a shotgun.

The one or more shock tower reinforcements may be located proximate to a shock tower. The one or more shock tower reinforcements may be located onto a portion of the shock tower. The shock tower reinforcement may form a complementary fit with said portion of the shock tower. The one or more shock tower reinforcements may be fastened to said portion of the shock tower, e.g., by welding, mechanical fasteners, chemical fastener, or any combination thereof).

The one or more shock tower reinforcements may have a hollow region at least in a region between the longitudinal frame rail and the shotgun. The hollow region may be defined by two or more walls, more preferably three or more walls. The hollow region may be further defined by the portion of the shock tower onto which the shock tower reinforcement is located. The hollow region may have a generally polygonal cross-sectional shape (e.g., a rectangular shape). The cross-sectional shape may be viewed along a longitudinal axis of a shock tower reinforcement. The hollow region may have an open side, at least prior to disposing upon the shock tower. The open side may be oriented downward.

One or more reinforcing elements may be located in the hollow region. The one or more reinforcing elements may include one or more ribs, one or more brackets, one or more inserts, a foam (e.g., an expandable structural foam), or any combination thereof.

The shock tower reinforcement may comprise one or more flanges. A first flange and a second flange may be located respectively on opposing longitudinal sides of the hollow portion. The shock tower reinforcement may be fastened to the shock tower at the flanges.

The first end of the one or more shock tower reinforcements may at least partially wrap around the longitudinal frame rail or may engage with a surface of the longitudinal frame rail. The second end of the one or more shock tower reinforcements may at least partially wrap around the shotgun or may engage with a surface of the shotgun. The first end may be fastened to the longitudinal frame rail by, e.g., welding, mechanical fasteners, chemical fastener, or any combination thereof. The second end may be fastened to the shotgun by, e.g., welding, mechanical fasteners, chemical fastener, or any combination thereof.

The one or more shock tower reinforcements may be monolithic in construction. The one or more shock tower reinforcements may comprise two or more segments. The two or more segments may be connected. The two or more segments may be fastened together by, e.g., welding, mechanical fasteners, chemical fastener, or any combination thereof. The two or more segments may at least partially overlap.

In one exemplary aspect, a shock tower reinforcement may comprise a first segment connected at a first end thereof to a longitudinal frame rail and a second segment connected at a first end thereof to a shotgun, and the first and second segments being connected at respective second ends thereof.

In another exemplary aspect, a shock tower reinforcement may comprise one segment. That is, the shock tower reinforcement may be monolithic in construction.

The shock tower reinforcement may function in a frontal impact collision. The shock tower reinforcement may transfer force from the longitudinal frame rail to the shotgun. Said force transfer may have an effect of bracing the shotgun and mitigating deformation of the shotgun, at least in a region or reinforcement rearward of the shock tower reinforcement, toward the occupant compartment. In this regard, the shotgun and the shock tower reinforcement may cooperate in function during a collision. The shock tower reinforcement may deform during a collision to absorb energy.

The vehicle frame subassembly may comprise one or more rockers. The one or more rockers may be primarily functional during a front impact collision or a side impact collision.

The rocker may be located along or proximate to a bottom edge of the vehicle frame. The rocker may extend longitudinally between a front end and a rear end of the vehicle frame. The rocker may be located between front and rear wheel wells of the vehicle frame. The rocker may extend to a front edge of a hinge pillar. The rocker may extend to or proximately to a rear wheel well.

The rocker may extend to the hinge pillar. The rocker may be connected to the hinge pillar. The rocker may be fastened to the hinge pillar (e.g., via welding, mechanical fasteners, chemical fastener, or any combination thereof). Connection to the hinge pillar may provide transfer of forces through the hinge pillar to the rocker. This may be advantageous at least in a frontal impact collision (e.g., a small overlap frontal impact), in which deformation of the wheel may cause the wheel to impact and deform the hinge pillar. However, by the connection of the rocker to the hinge pillar, forces transferred thereto can be transferred through the rocker and the rocker may support the hinge pillar to mitigate deformation of the same.

The rocker may at least partially define one or more entry ways. The rocker may be connected to one or more pillars (e.g., a hinge pillar, a B-pillar, or both), a floor pan, or both. It is contemplated that one or more elements of the rocker may be structurally shared by adjacent vehicle frame elements. By way of example, an outer segment of a rocker extending into a region of the hinge pillar or the B-pillar.

The rocker may comprise one or more segments. The one or more segments may include at least first segment and one or more reinforcement segments. The first segment may function as an attachment surface or a containment for the one or more reinforcing segments.

In one exemplary aspect, the rocker may comprise a reinforcement segment in the form of an extrusion that extends between the front and rear wheel wells, the extrusion defining one or more ribs. The rocker may further comprise a first segment that extends over the reinforcing segment and fastens onto the vehicle frame to secure the reinforcing segment.

In one exemplary aspect, the rocker may comprise an inner segment, an outer segment, and one or more reinforcement segments located between the inner segment and the outer segment. The inner segment may be located inboard of the outer segment. The inner segment and the outer segment may be fastened together (e.g., via welding, mechanical fasteners, chemical fastener, or any combination thereof). The one or more reinforcement segments may be fastened (e.g., via welding, mechanical fasteners, chemical fastener, or any combination thereof) to the inner segment, the outer segment, or both. Preferably, the one or more reinforcement segments may be fastened to the inner segment.

The one or more reinforcement segments may comprise one or more ridges. The one or more ridges may be formed by one or more bends in the reinforcement segments. The bends may be located between planar portions of the one or more reinforcement segments. The reinforcement segments may be bent such that the two planar portions leading to a bend are generally parallel, or are skewed relative to each other. The skew angle may be about 1 degree or more, 2 degrees or more, 3 degrees or more, 4 degrees or more, 5 degrees or more, 6 degrees or more, 7 degrees or more, 8 degrees or more, 9 degrees or more, or even 10 degrees or more. The skew angle may be about 20 degrees or less, 19 degrees or less, 18 degrees or less, 17 degrees or less, 16 degrees or less, 15 degrees or less, 14 degrees or less, 13 degrees or less, 12 degrees or less, or even 11 degrees or less.

The one or more reinforcement segments may include one or more reinforcement segments having three bends, one or more reinforcement segments having one bend, or any combination thereof. One or more of the three-bend reinforcement segments may at least partially overlap with one or more of the one-bend reinforcement segments. Two or more three-bend reinforcement segments may at least partially overlap. Two or more one-bend reinforcement segments may at least partially overlap. One or more of the three-bend reinforcement segments may be located adjacent to one or more other three-bend reinforcement segments. One or more of the one-bend reinforcement segments may be located adjacent to one or more other one-bend reinforcement segments.

In one preferred example, the one or more reinforcement segments may include: a first reinforcement segment, having three bends, located with one end thereof proximate to a hinge pillar and extending only partially the length of the rocker; a second reinforcement segment, having one bend, extending along the rocker such that a first end thereof is proximate to the hinge pillar and a second end thereof is proximate to a rear wheel well, and where the second reinforcement segment partially overlaps with the first reinforcement segment; and a third reinforcement segment, having one bend, that is located adjacent to the second reinforcement segment and located with one end thereof proximate to the rear wheel well, and extending only partially the length of the rocker.

The multi-segment approach may be advantageous for strategically locating reinforcement while eliminating some material and accordingly weight and cost compared to, for example, only reinforcements that extend along the entire length or substantially the entire length of the rocker.

The rocker may function in a frontal impact collision. In the event of a frontal collision, forces travelling through a shotgun and/or a longitudinal frame rail may be received by a hinge pillar. Then, the forces may be distributed, from the hinge pillar, up to the A-pillar and down to the rocker. At least a portion of the forces may be transferred to the B-pillar. In this regard, the rocker may substantially maintain its structure, mitigate deformations to the occupant compartment, and transfer forces along the length of the vehicle.

The rocker may function in a side impact collision. In the event of a side collision, the rocker may at least partially deform in a pre-determined manner and absorb energy to mitigate intrusion into the occupant compartment.

The vehicle frame subassembly may comprise one or more tension braces. The one or more tension braces may also be referred to as hinge pillar reinforcements. The one or more tension braces may contact the hinge pillar, the longitudinal frame rail, the rocker, or any combination thereof. The one or more tension braces may connect the hinge pillar, the longitudinal frame rail, the rocker, or any combination thereof. The one or more tension braces may be located over the hinge pillar, the longitudinal frame rail, the rocker, or any combination thereof. The one or more tension braces may be fastened to (e.g., via welding, mechanical fasteners, chemical fastener, or any combination thereof) the hinge pillar, the longitudinal frame rail, the rocker, or any combination thereof. The one or more tension braces may wrap around a bottom corner of the vehicle frame, a side corner of the vehicle frame, or both.

The one or more tension braces may function to substantially mitigate delamination of connections of the hinge pillar, the longitudinal frame rail, the rocker, or any combination thereof. In this regard, it has been observed that absent one or more tension braces, welds or other means of connection described herein can separate along these elements. In one example, at least the rocker may be susceptible to delamination, possibly along at least a portion of the length of the rocker (e.g., welds between a rocker inner and a rocker outer).

In one exemplary aspect, the one or more tension braces is one tension brace that may contact the hinge pillar, the longitudinal frame rail, and the rocker. The tension brace may include a first segment that contacts a longitudinal frame rail, a hinge pillar, and a front side of the rocker; and a second segment that contacts an underside of the rocker. The tension brace may wrap around a bottom corner of the vehicle frame.

The one or more tension braces may include at least two tension braces. A first tension brace may connect to the hinge pillar, the longitudinal frame rail, and the rocker. A second tension brace may connect to the rocker and the longitudinal frame rail. The first and second tension braces may at least partially overlap. Such overlapping may be in the region to which they connect to the longitudinal frame rail. The first tension brace may wrap around a side corner of the vehicle frame. The second tension brace may wrap around a bottom corner of the vehicle frame.

The vehicle frame subassembly may comprise one or more hinge pillars. The one or more hinge pillars may define a portion of an entry way. The one or more hinge pillars may be adjacent to an A-pillar on one side thereof. The one or more hinge pillars may be adjacent to a rocker on another side thereof. The hinge pillar may be connected to a shotgun. Forces from the shotgun may be transferred to the hinge pillar. The hinge pillar may transfer forces to the A-pillar, the rocker, or both.

The vehicle frame subassembly may comprise one or more hinge pillar reinforcements. The one or more hinge pillar reinforcements may be in the form of a plate that contours to the hinge pillar. The one or more hinge pillar reinforcements may be located on an inboard side of the hinge pillar, an outboard side of the hinge pillar, or both. Preferably the one or more hinge pillar reinforcements may be located on at least an inboard side of the hinge pillar.

The hinge pillar reinforcement may mitigate deformation of at least a portion of the floor pan propagating inward from the hinge pillar. In one particular example, the hinge pillar reinforcement may mitigate deformation of a heel rest on a driver side of the floor pan. Said deformation may be caused at least by deformation of a wheel that contacts the inboard side of the wheel well, which may otherwise cause deformation of the floor pan, leading to injuries of the feet or legs of an occupant.

The vehicle frame subassembly may comprise one or more A-pillars. The A-pillar may extend from a hinge pillar. The A-pillar may extend to a roof rail. The A-pillar may define at least a portion of an entry way, a windshield opening, or both.

The vehicle frame subassembly may comprise one or more B-pillars. The B-pillar may define at least a portion of an entry way. The B-pillar may be rearward of the A-pillar. The B-pillar may connect at one end to a roof rail and at an opposing end to a rocker.

The vehicle frame subassembly may comprise one or more floor boxes. The one or more floor boxes may connect to the longitudinal frame rails, the rockers, the floor pan, or any combination thereof. Preferably, the one or more floor boxes may connect to the rockers and the floor pan. The one or more dark boxes may be fastened via welding, mechanical fasteners, chemical fastener, or any combination thereof. The one or more tension braces described herein may extend at least partially over the floor box.

The one or more floor boxes may comprise one or more segments, more preferably two or more segments, or even more preferably three or more segments. In one exemplary arrangement, a first segment may connect to at least a floor pan, a second segment may connect to at least a rocker, and a third segment may extend over a portion of the first segment and a portion of the second segment.

The one or more floor boxes may function to aid in mitigating or substantially mitigating intrusion of the wheel into the floor pan, supporting against deformation of the floor pan in the region of an occupant’s feet, or both.

The vehicle frame subassembly may comprise a firewall. The firewall may separate the occupant compartment from a front end of the vehicle. The firewall may include two or more segments. The two or more segments may include a top segment and a bottom segment. The top segment and the bottom segment may differ in one or both of material and thickness.

The bottom segment may be more robust compared to the top segment. In this regard, it is contemplated that the bottom segment receives force transferred at least from the longitudinal frame rails and is located proximate to and/or is connected to the hinge pillars, which receives force transferred from the longitudinal frame rails and/or the shotguns. The bottom segment may also transfer force transversely along the bottom segment.

The bottom segment may be fabricated from a higher grade metal compared to the top segment. The bottom segment may be fabricated from HSLA 550 steel. The top segment may be fabricated from HSLA 270 steel.

The bottom segment may be defined by a greater thickness compared to the top segment. The bottom segment may have a thickness of about 1 millimeter to about 3 millimeters, more preferably about 1.2 millimeters to about 2 millimeters, more preferably about 1.5 millimeters. The top segment may have a thickness of about 0.5 millimeters to about 1.5 millimeters, more preferably about 0.8 millimeters to about 1.2 millimeters, more preferably about 1 millimeter.

The vehicle frame subassembly may comprise one or more floor reinforcements. The one or more floor reinforcements may extend at least partially over the floor pan. The one or more floor reinforcements may function to at least partially mitigate deformation of the floor pan.

The floor reinforcement may include a segment that is generally trapezoidal in profile, and extend toward the firewall, beyond at least a portion of the front wheel well. The floor reinforcement may be located at least partially under a tunnel reinforcement described herein.

The floor reinforcement may include an edge that locates against or proximate to the firewall (e.g., a bottom segment of the firewall). The floor reinforcement may include a second edge opposing the first edge. The second edge may extend to or approximately to rear of the front wheel well or beyond the rear of the front wheel well. The second edge may extend to a front seat crossmember or to a region between the rear of the front wheel well and the front seat crossmember. The second edge may extend to a rear seat crossmember or to a region between the front seat crossmember and the rear seat crossmember.

The floor reinforcement may be fabricated from a higher grade metal compared to the floor pan, may be defined by a greater thickness compared to the floor pan, or both.

The vehicle frame subassembly may comprise one or more tunnel reinforcements. The one or more tunnel reinforcements may be located over a tunnel formed in the floor pan. The one or more tunnel reinforcements may function to at least partially mitigate deformation of the floor pan. The one or more tunnel reinforcements may transfer forces to a vehicle seat crossmember (e.g., front vehicle seat crossmember) formed into the floor pan.

The tunnel reinforcement may be fabricated from a higher grade metal compared to the tunnel of the floor pan. The tunnel reinforcement may be fabricated from HSLA 550 steel.

The tunnel reinforcement may have a greater thickness compared to the tunnel of the floor pan. The tunnel reinforcement may have a thickness of about 1.5 millimeters to about 2.5 millimeters, more preferably about 1.8 millimeters to about 2.2 millimeters, more preferably about 2 millimeters.

In one exemplary small-offset frontal overlap impact sequence, a vehicle may collide with an object on a front corner of the vehicle. The bumper beam may contact the object and deform and energy may then be directed to the crush can, which may deform to absorb energy. A portion of the crush can may be juxtaposed with an end of the longitudinal frame rail and a portion of the crush can may be juxtaposed with the blocker. Accordingly, some energy may be transferred down the length of the longitudinal frame rail and some energy may be directed into the blocker. As a result, the blocker may pivot toward a centerline of the vehicle, directing energy through the crossmember connected to the longitudinal frame rail and influencing bending of the longitudinal frame rail in the region of the crossmember. Energy may also be directed transversely through the cradle. Energy that travels the entire length of the longitudinal frame rail, and which is not absorbed by deformations, may be distributed to the firewall through the connection of the longitudinal frame rail with the firewall.

Additionally, the shotgun may be connected to the blocker or proximate to the blocker. Thus, energy may also be distributed through the shotgun and a portion of the shotgun may deform, absorbing energy. Energy travelling through the longitudinal frame rail and involved in bending of the longitudinal frame rail may travel toward the shotgun, through the shock tower reinforcement. Energy that travels the entire length of the shotgun, and which is not absorbed by deformations, may be distributed to a hinge pillar, and thereafter to an A-pillar and shotgun.

The floor reinforcement and/or the tunnel reinforcement may mitigate deformations of the floor pan, which may otherwise injure occupants by, e.g., transmitting energy to the occupant’s feet. The energy travelling down the tunnel and tunnel reinforcement may be transferred to the front-most seat crossmember, which may distribute energy across the floor pan.

By the absorption and distribution of energy through the vehicle frame subassembly described above, an object may be precluded from penetrating into the occupant compartment, such as beyond the hinge pillar; deformations of the portions of the vehicle frame defining the occupant compartment may be mitigated; or both. Additionally, transverse redirection of forces via at least the crossmember and the cradle provides for a Y-push path of the vehicle off of the object.

In one exemplary full frontal rigid barrier impact sequence, a vehicle may collide with an object on a broadside surface of the bumper beam. The bumper beam may contact the object and deform and energy may then be directed to the crush cans, which may deform to absorb energy. Energy may be transferred down the length of the longitudinal frame rail and to the firewall. Additionally, the longitudinal frame rail may deform in a Z-shape and absorb energy. The cradle may also deform in a Z-shape and absorb energy. In this regard, the cradle may peel away from one or more connections with the longitudinal frame rails and/or the floor pan, thus absorbing energy.

Additionally, the shotgun may be connected to the blocker or proximate to the blocker. Thus, energy may also be distributed through the shotgun and a portion of the shotgun may deform, absorbing energy. Energy travelling through the longitudinal frame rail and involved in bending of the longitudinal frame rail may travel toward the shotgun, through the shock tower reinforcement. Energy that travels the entire length of the shotgun, and which is not absorbed by deformations, may be distributed to a hinge pillar, and thereafter to an A-pillar and shotgun.

The floor reinforcement and/or the tunnel reinforcement may mitigate deformations of the floor pan, which may otherwise injure occupants by, e.g., transmitting energy to the occupant’s feet. The energy travelling down the tunnel and tunnel reinforcement may be transferred to the front-most seat crossmember, which may distribute energy across the floor pan.

By the absorption and distribution of energy through the vehicle frame subassembly described above, an object may be precluded from penetrating into the occupant compartment, deformations of the portions of the vehicle frame defining the occupant compartment may be mitigated, or both.

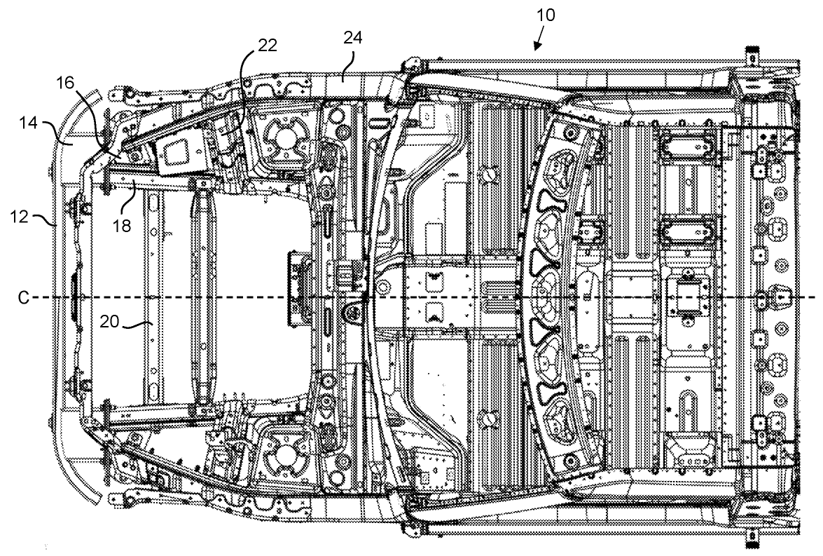

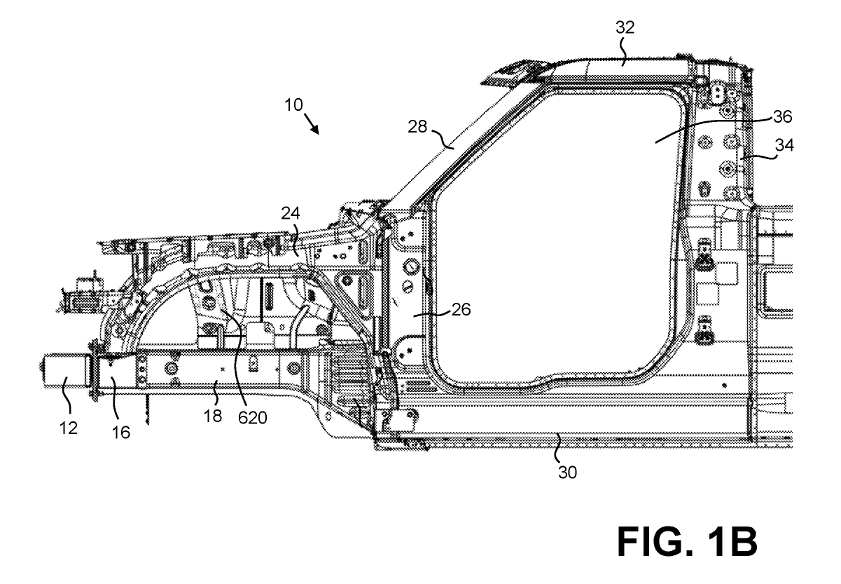

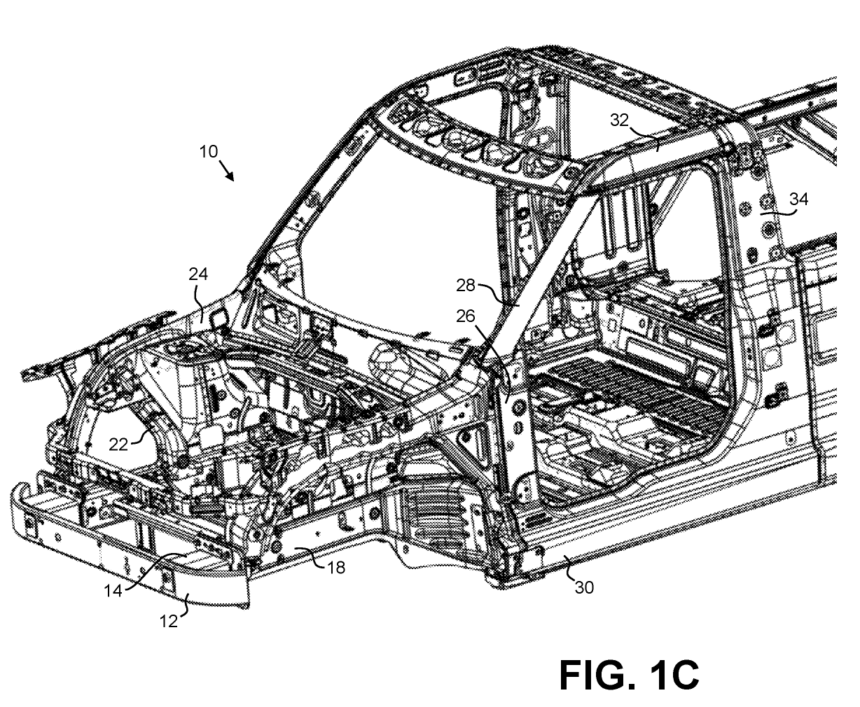

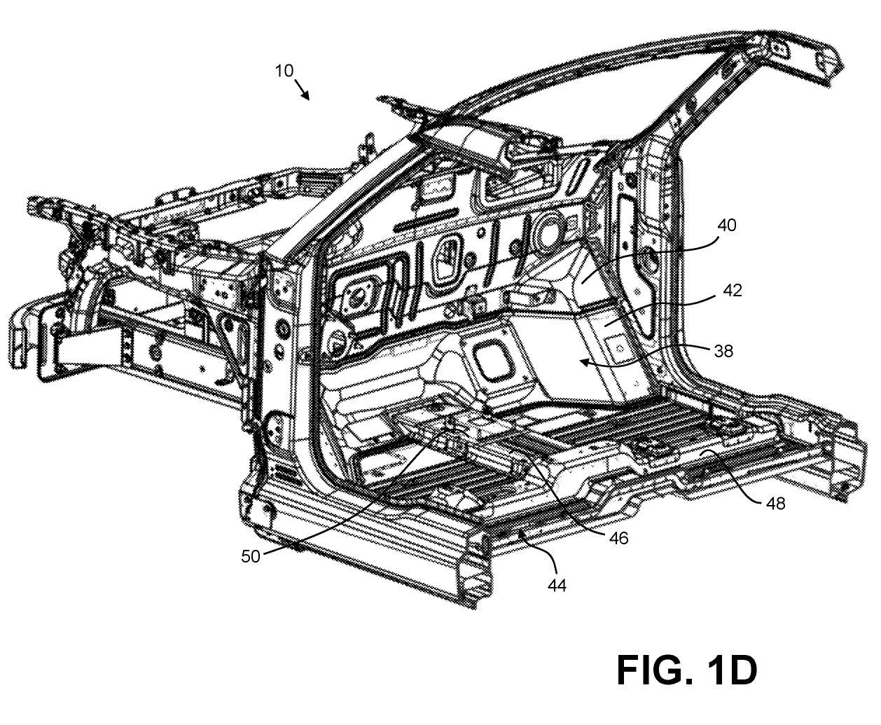

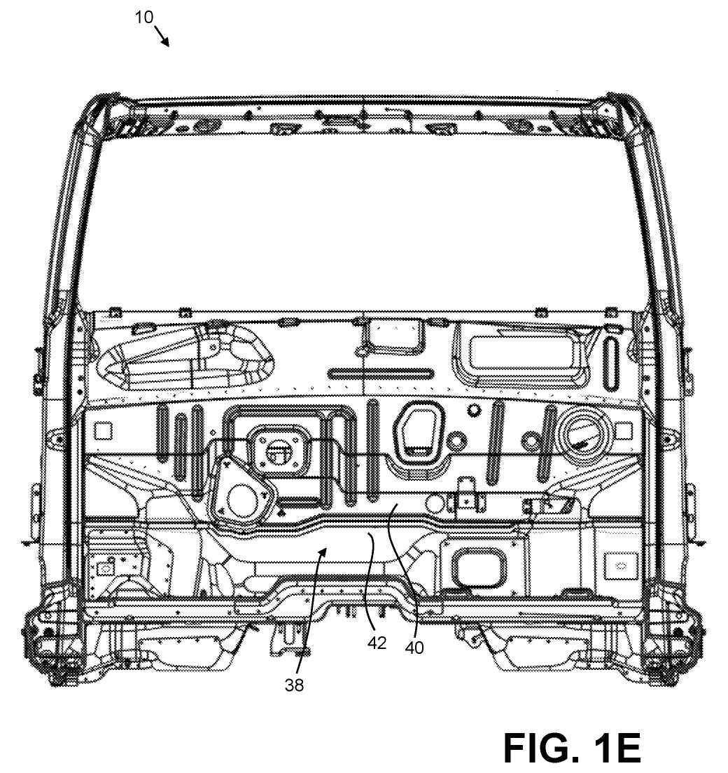

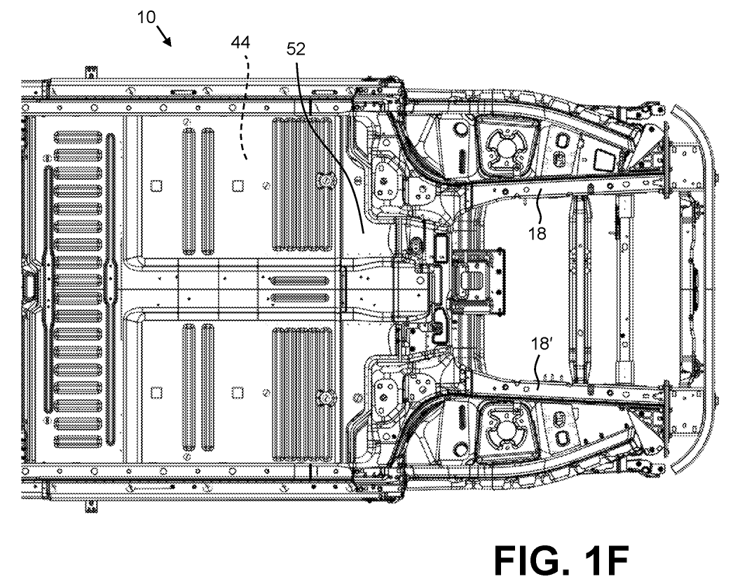

FIGS. 1A - 1F illustrate a vehicle frame 10. The vehicle frame 10 comprises a bumper beam 12 at a front end thereof to which crush cans 14 are connected. Blockers 16 and longitudinal frame rails 18 are connected to the crush cans 14. A crossmember 20 extends between the longitudinal frame rails 18. The vehicle frame 10 comprises shock tower reinforcements 22, which connect at one end to the longitudinal frame rails 18. The vehicle frame 10 comprises shotguns 24, which connect at one end to the blockers 16, and to which the shock tower reinforcements 22 connect to at an end opposing the end connected to the longitudinal frame rails 18.

The vehicle frame 10 comprises a hinge pillar 26 to which the shotguns 24 connect. Extending up from the hinge pillar 26 is an A-pillar 28 and below the hinge pillar 26 is a rocker 30. The A-pillar 28 connects to a roof rail 32, which extends back to a B-pillar 34. The rocker 30 connects to a bottom of the B-pillar 34. The hinge pillar 26, A-pillar 28, roof rail 32, B-pillar 34, and rocker 30 cooperate to define an entry way 36.

The vehicle frame 10 comprises a firewall 38. The firewall 38 includes a top segment 40 and a bottom segment 42. The bottom segment 42 is connected to the longitudinal frame rails 18 on opposing sides thereof.

The vehicle frame comprises a floor pan 44 which defines in a portion thereof a tunnel 46. A seat crossmember 48 extends transversely over the floor pan 44. A tunnel reinforcement 50 is disposed over a forward-most portion of the tunnel 46.

A floor pan reinforcement 52 extends over the floor pan 44 along the length of the passenger compartment and extending into the region within the profile of the bottom segment 42 of the firewall 38.

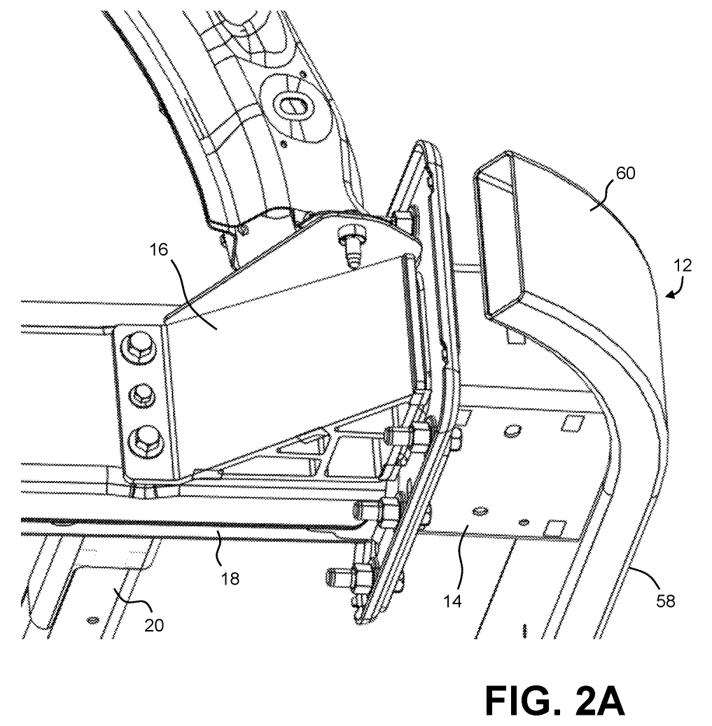

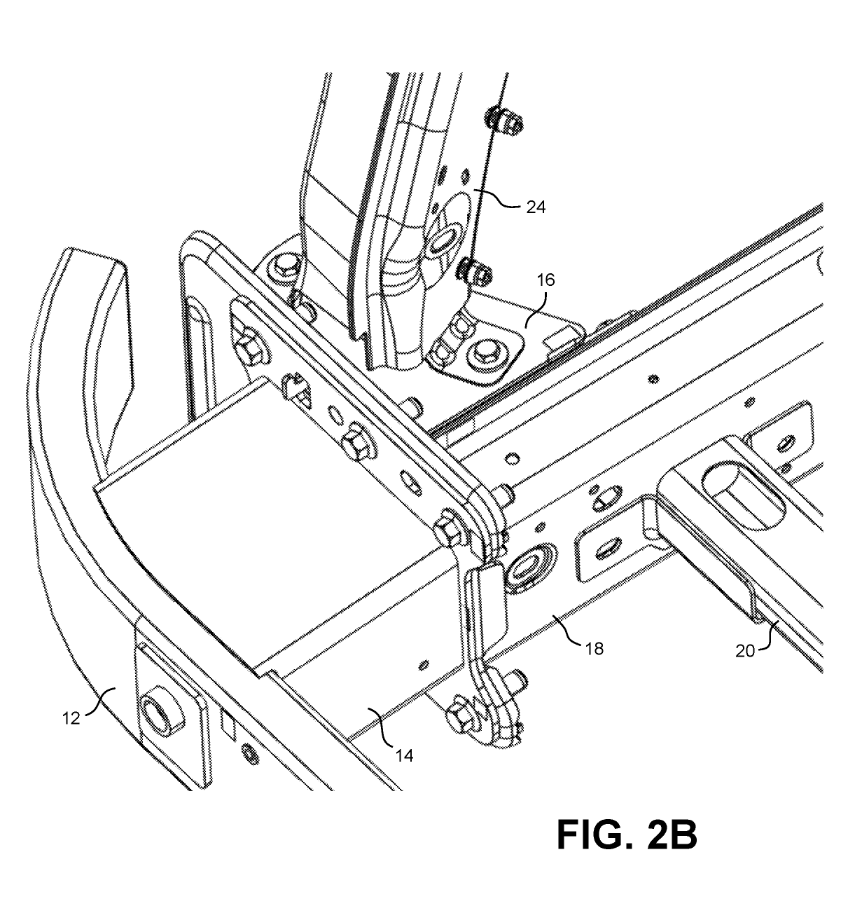

FIGS. 2A and 2B illustrate a front end of the vehicle frame 10. The bumper beam 12 is connected to the crush can 14, which is connected to the blocker 16 and the longitudinal frame rail 18. The shotgun 24 is also connected to the blocker 16.

It can be seen that the blocker 16 is at least partially juxtaposed with the crossmember 20. In this regard, pivoting of the blocker 16 transfers forces to the crossmember 20. It can also be seen that a portion of the crush can 14 is juxtaposed with the blocker 16 and another portion of the crush can is juxtaposed with the longitudinal frame rail 18. Thus, it can be appreciated that in, for example, a small-offset frontal overlap impact collision, forces travelling through the crush can 14 in the region of the blocker 16 transfer to the blocker 16, causing the blocker 16 to pivot and transfer force to the crossmember 20.

It can also be appreciated that at the depicted junction of elements, forces are absorbed and transferred in a multitude of modes. Prior to the blocker 16 and longitudinal frame rail 18, deformation of the bumper beam 12 and the crush can 14 absorbs energy. The force is transferred up to the shotgun 24 and back through the longitudinal frame rail 18. Continued propagation of these forces will be discussed below.

The bumper beam 12 is defined by a central portion 58 and end portions 60. The end portions 60 have a curvature that promote a gliding action against a barrier.

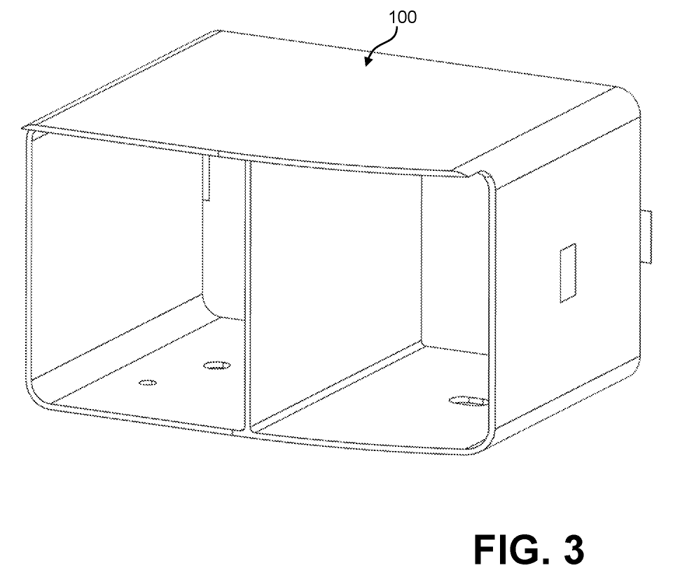

FIG. 3 illustrates an exemplary crush can 100. The crush can 100 is in the form of a dual crush can, whereby a wall extends through the crush can 100 and divides two hollow regions.

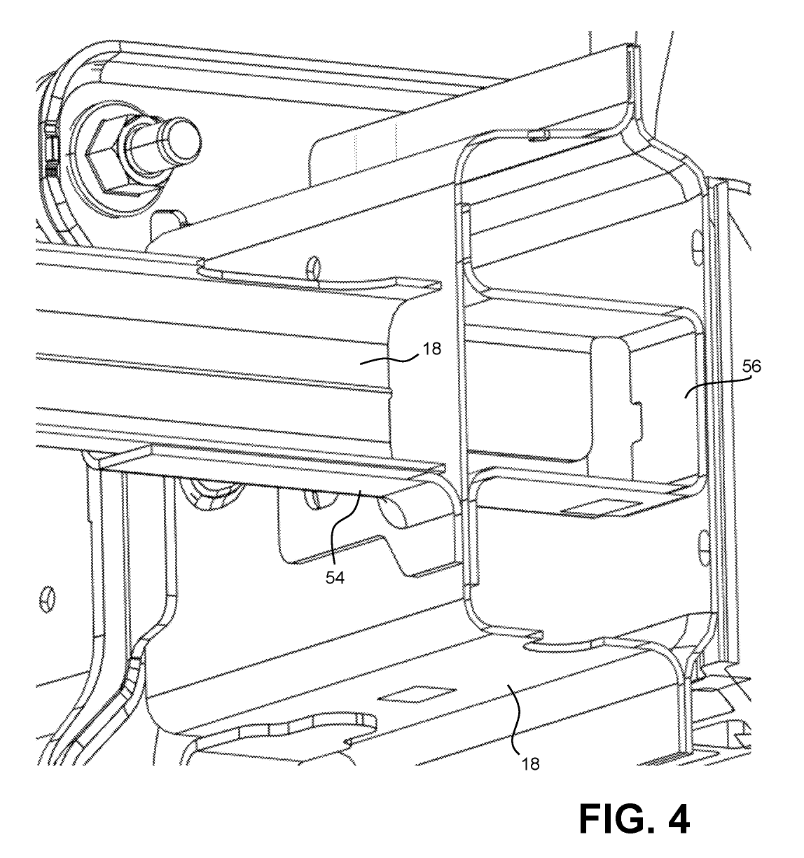

FIG. 4 illustrates the structural relationship between the crossmember 20 and the longitudinal frame rail 18. The crossmember 20 abuts the longitudinal frame rail 18 and is connected thereto via a bracket 54. An insert 56 is located within the longitudinal frame rail 18 and is juxtaposed with the crossmember 20 and the bracket 54. In this regard, the insert 56 aids in force transfer through the crossmember 20 to the longitudinal frame rail 18 by bridging between the inner and outer portions of the longitudinal frame rail 18.

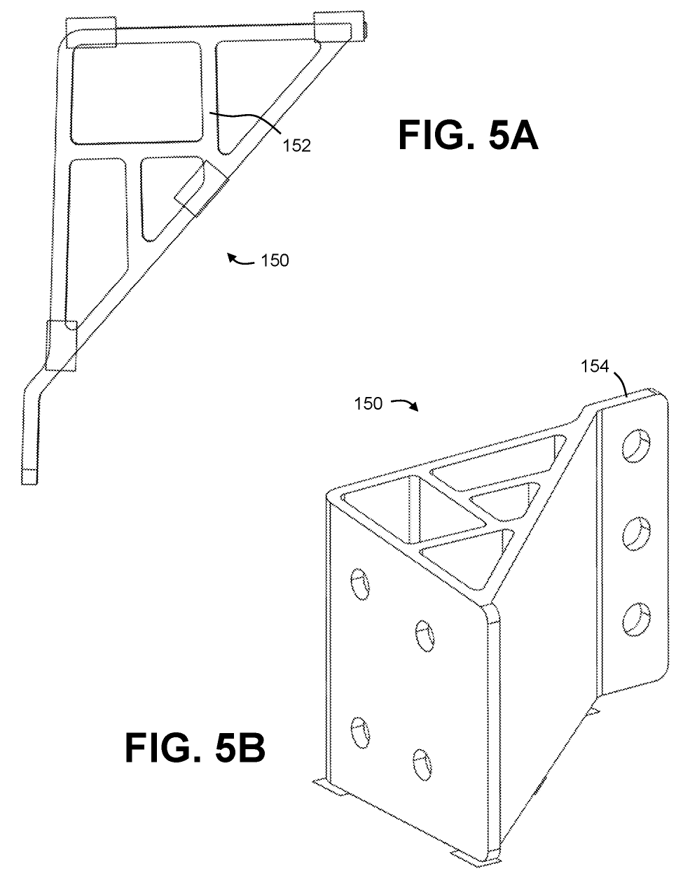

FIGS. 5A and 5B illustrate an exemplary blocker 150. The blocker 150 is generally wedge-shaped, which lends to its pivoting function toward the centerline C of the vehicle frame 10 described herein. The blocker 150 comprises ribs 152 in an interior portion thereof. The ribs 152 include longitudinally-extending ribs and transversely-extending ribs. The blocker 150 includes a flange 154, which is fastened (e.g., M12 bolts) to a longitudinal frame rail, such as shown in FIG. 4.

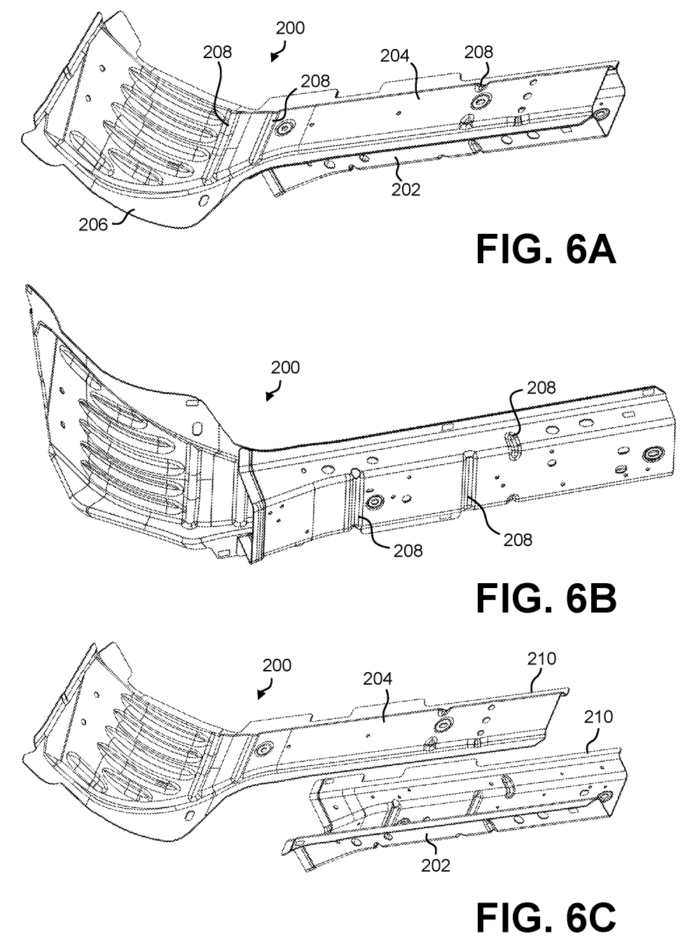

FIGS. 6A - 6C illustrate an exemplary longitudinal frame rail 200. The longitudinal frame rail 200 includes a first segment 202 adapted to orient inboard and a second segment 204 adapted to orient outboard. The second segment 204 includes a wing 206 that extends out to connect to a hinge pillar, discussed below. The first and second segments 202, 204 include stress concentrators 208. Some of the stress concentrators 208 are located at corners and some of the stress concentrators 208 extend between corners, along a surface thereof. The stress concentrators 208 at the corners are provided as pairs which are axially aligned. The first and second segments 202, 204 each include on opposing sides thereof flanges 210 by which the segments 202, 204 can be fastened, e.g., via welding, mechanical fasteners, chemical fastener, or any combination thereof.

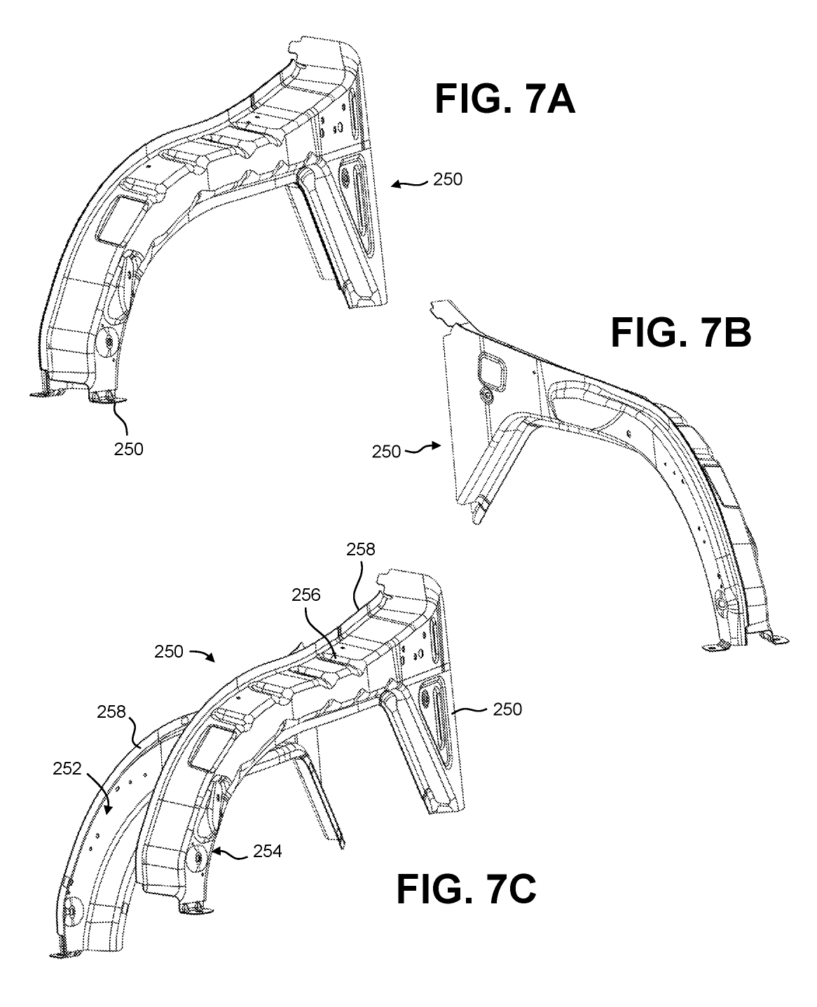

FIGS. 7A - 7C illustrate an exemplary shotgun 250. The shotgun 250 includes a first segment 252 adapted to orient inboard and a second segment 254 adapted to orient outboard. The first and second segments 252, 254 include stress concentrators 256. The stress concentrators 256 extend along top and bottom surfaces of the shotgun 250. The stress concentrators 256 are provided as top and bottom pairs which are axially aligned. The first and second segments 252, 254 each include on opposing sides thereof flanges 258 by which the segments 252, 254 can be fastened, e.g., via welding, mechanical fasteners, chemical fastener, or any combination thereof. The shotgun 250 has a flared portion 260 having a generally triangular shape which is adapted to connect to a hinge pillar and distribute force transfer along the hinge pillar. The shotgun 250 includes flanges 262 for connecting to a blocker, such as shown in FIG. 2B.

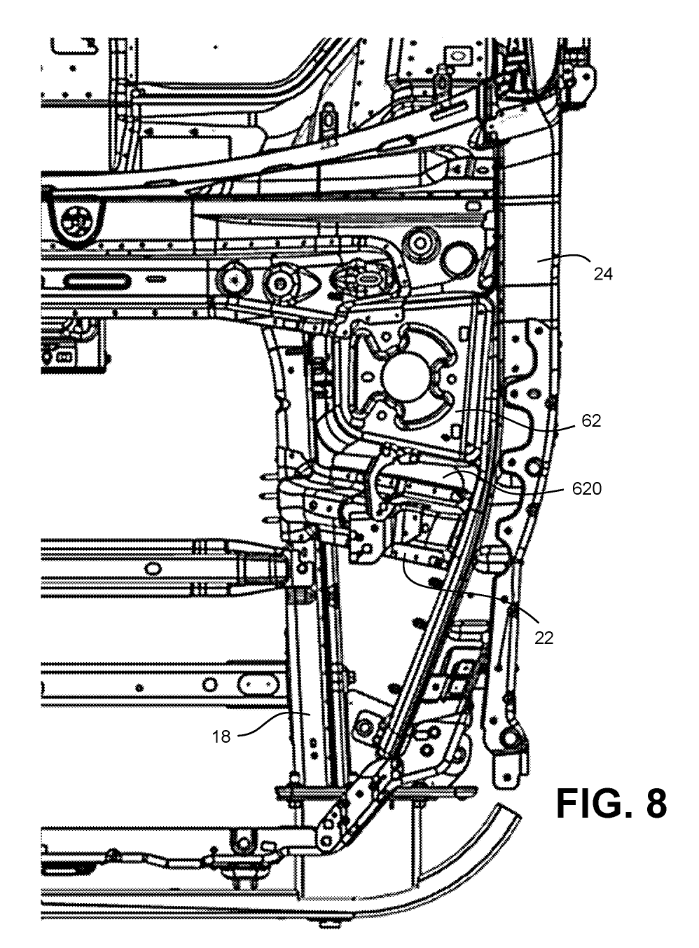

FIG. 8 illustrates a portion of the vehicle frame 10 including the shock tower reinforcement 22. The shock tower reinforcement 22 is connected at one end to the longitudinal frame rail 18 and at an opposing end to the shotgun 24. The shock tower reinforcement 22 is located proximate to a shock tower 62. In a collision, the front end of the shotgun 24 and the longitudinal frame rail 18 may deform. Continued deformation of the shotgun 24 beyond the shock tower 62 may be prevented or at least partially mitigated by the bracing of the shock tower reinforcement 22. As shown from a different angle in FIG. 1B, a portion 620 of the shock tower 62 extends underneath the shock tower reinforcement 22, and so the shock tower reinforcement 22 is located upon said portion 620.

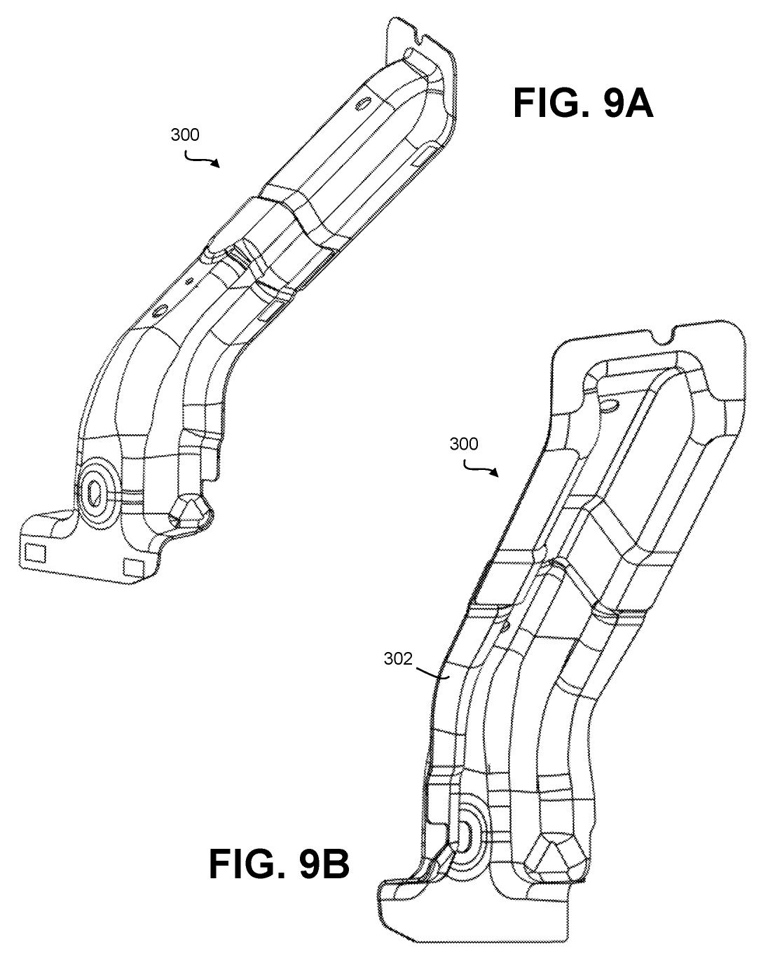

FIGS. 9A and 9B illustrate an exemplary shock tower reinforcement 300. The shock tower reinforcement 300 is monolithic in construction. The shock tower reinforcement 300 is bent to define a cavity, and has a flange 302 that extends at least partially therearound. The end that connects to a longitudinal frame rail is adapted and configured to wrap around a corner of the longitudinal frame rail.

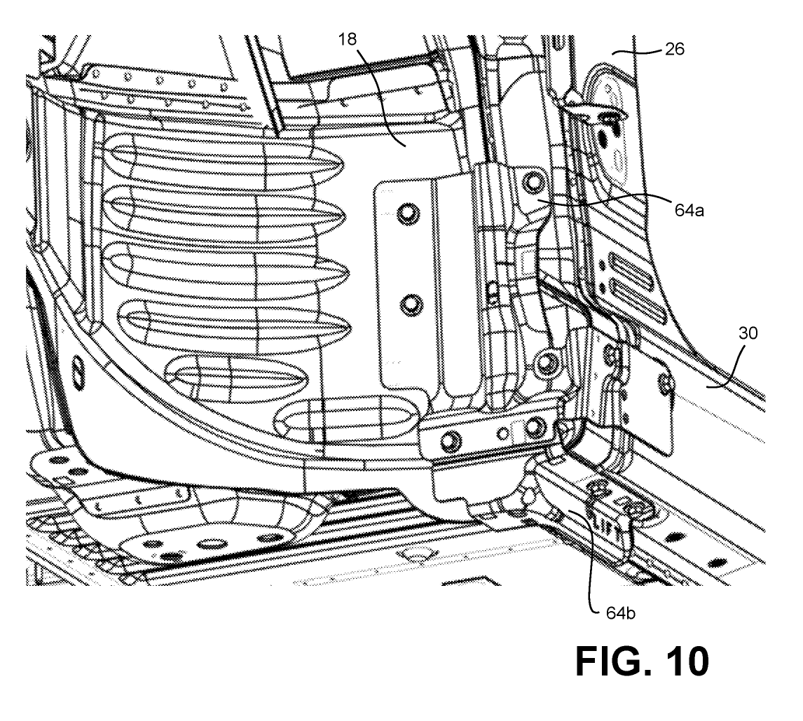

FIG. 10 illustrates the structural relationship of the longitudinal frame rail 18, the hinge pillar 26, and the rocker 30. The vehicle frame 10 comprises two tension braces 64a, 64b that reinforce this region. A first tension brace 64a includes a first portion that extends over the longitudinal frame rail 18 and a second portion that extends over the rocker 30. A second tension brace 64b includes a first portion that extends over the longitudinal frame rail 18 and a second portion that extends over the rocker 30. The first portion of the second tension brace 64b is overlapped by the first portion of the first tension brace 64a. The tension braces 64a, 64b prevent or at least substantially mitigate delamination of fastening means in this region, where otherwise delamination has been observed to be capable of propagating at least partially down the length of the rocker.

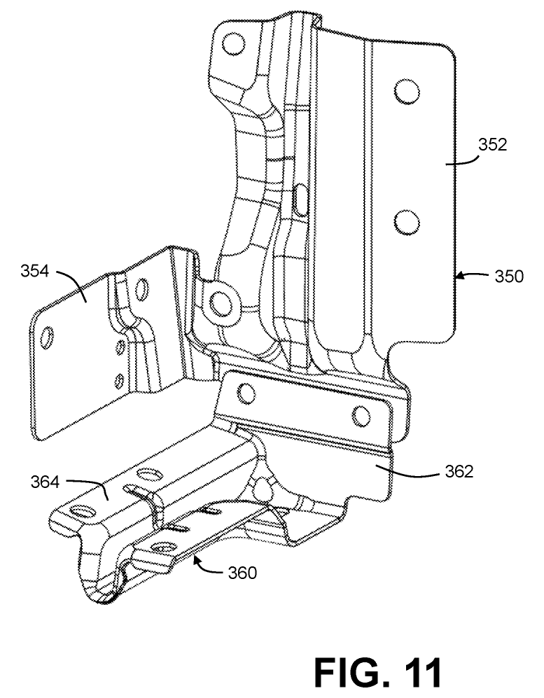

FIG. 11 illustrates exemplary tension braces 350, 360. The tension brace 350 includes a first portion 352 and a second portion 354. The tension brace 360 includes a first portion 362 and a second portion 364. The first portion 352 of the tension brace 350 overlaps the first portion 362 of the tension brace 360. The tension braces 350, 360 include a plurality of fastener holes for receiving fasteners, such as bolts.

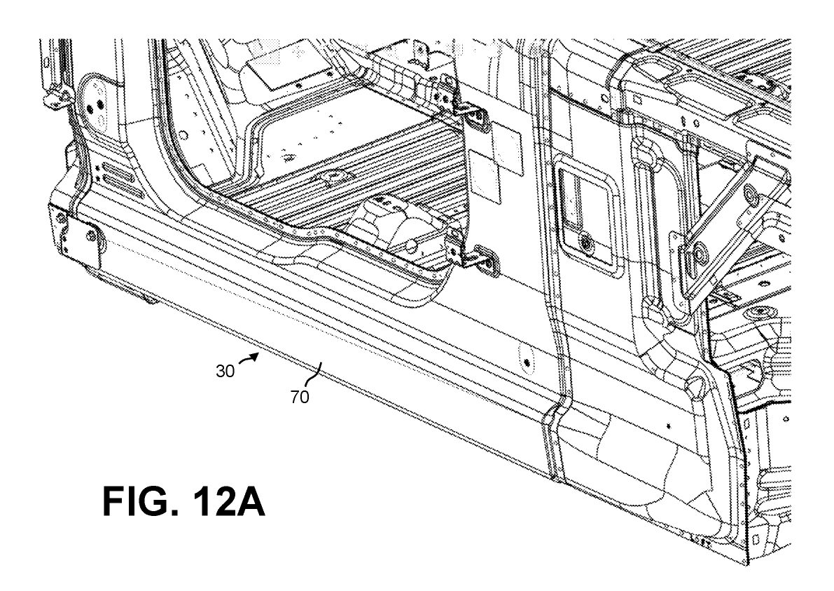

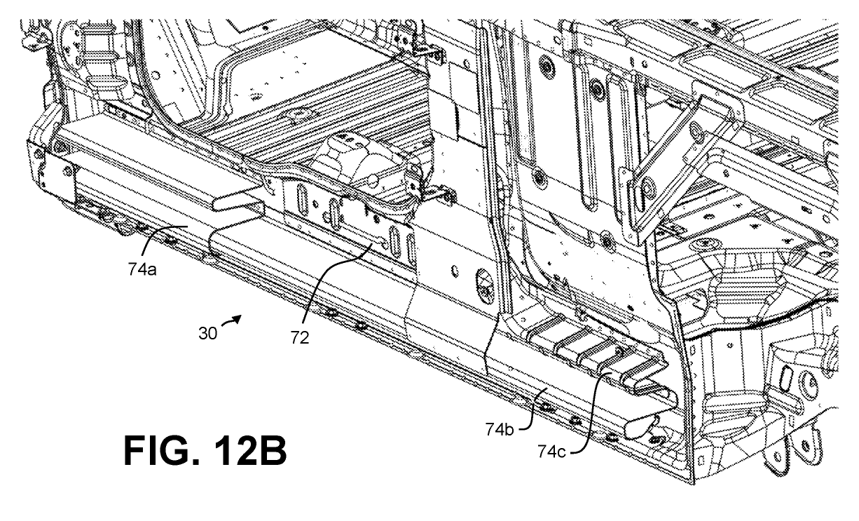

FIGS. 12A and 12B illustrate the rocker 30. The rocker 30 extends to the edge of the hinge pillar 26 to a rear wheel well. Locating the rocker 30 to the edge of the hinge pillar 26 provides for early wheel loading of the rocker 30 in the event the wheel contacts that region.

The rocker 30 comprises an outer segment 70, an inner segment 72, and reinforcement segments 74a, 74b, 74c located therebetween. The reinforcement segments 74a, 74b, 74c are provided in plurality and are discontinuous to eliminate structure and cost not required for desired collision performance. The reinforcement segments 74a, 74b, 74c are fastened to the inner segment 72. The reinforcement segment 74a comprises three bends, two located proximate to the outer segment 70 and one fastened to the inner segment 72. The reinforcement segment 74b extends substantially the length of the rocker 30 and is overlapped by the reinforcement segment 74a. The reinforcement segment 74c is located in the rear of the rocker 30 and is located adjacent to the reinforcement segment 74b, where a flange thereof overlaps a flange of the reinforcement segment 74b. The reinforcement segments 74b, 74c each include one bend.

FIGS. 13A and 13B illustrate a hinge pillar reinforcement 80, which locates on an inboard surface of the hinge pillar 26 to reinforce the hinge pillar 26.

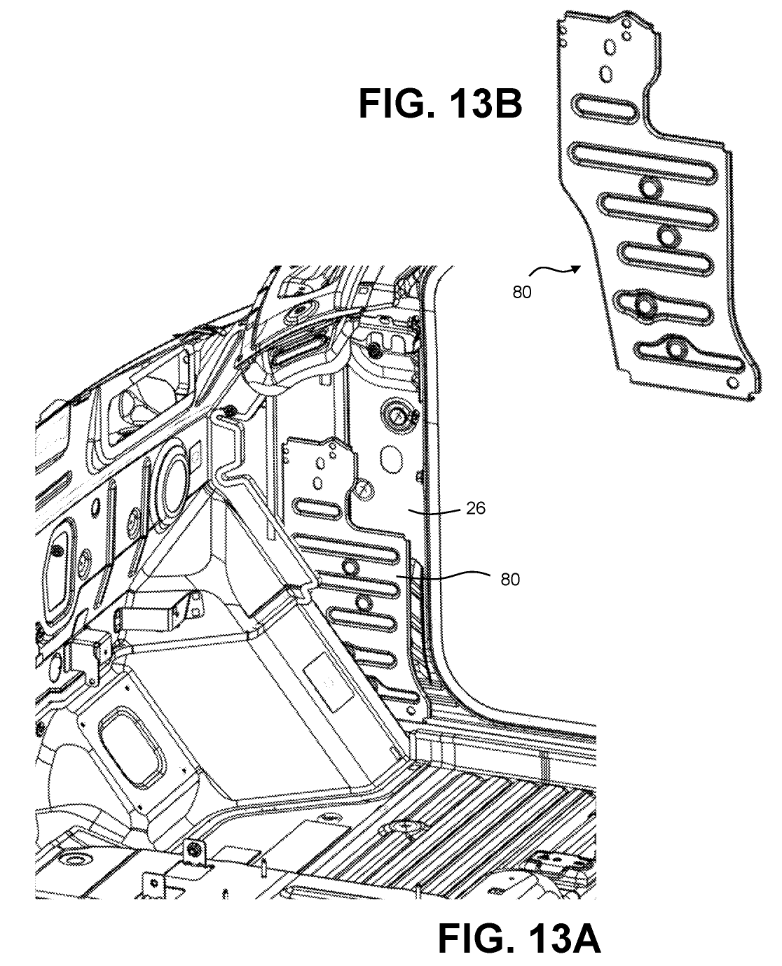

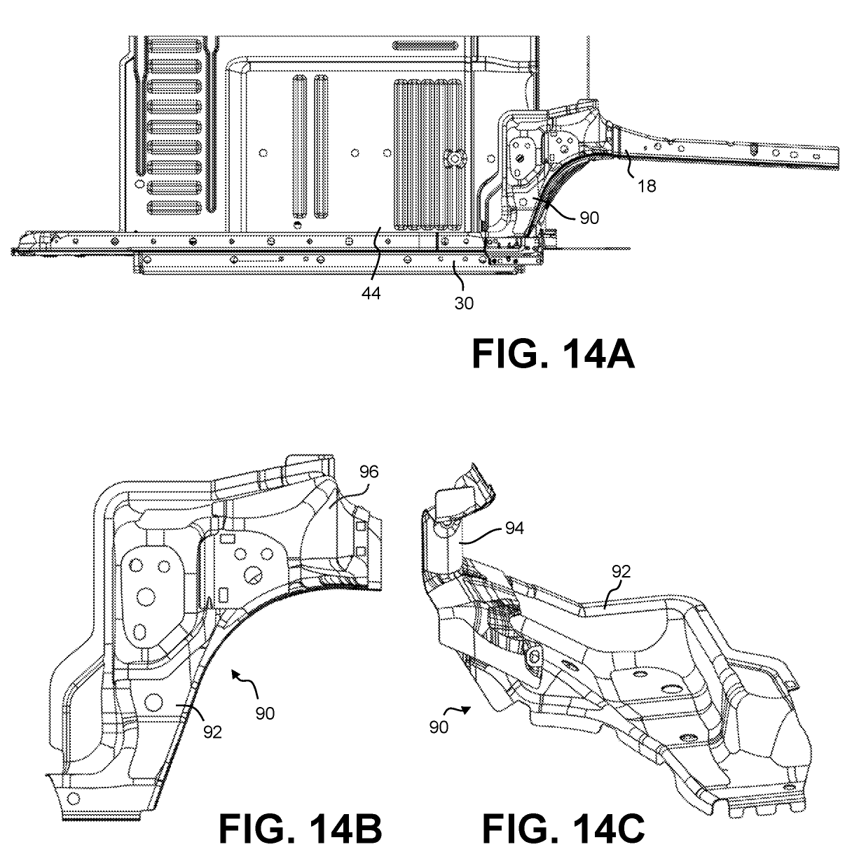

FIGS. 14A - 14C illustrate a floor box 90. The floor box 90 is connected to a longitudinal frame rail 18, a rocker 30, and a floor pan 44. The floor box 90 comprises a first segment 92, a second segment 94, and a third segment 96 that extends over a portion of the first segment 92 and the second segment 94. The first segment 92 is connected at least to the floor pan 44. The second segment 94 is connected to at least the rocker 30.

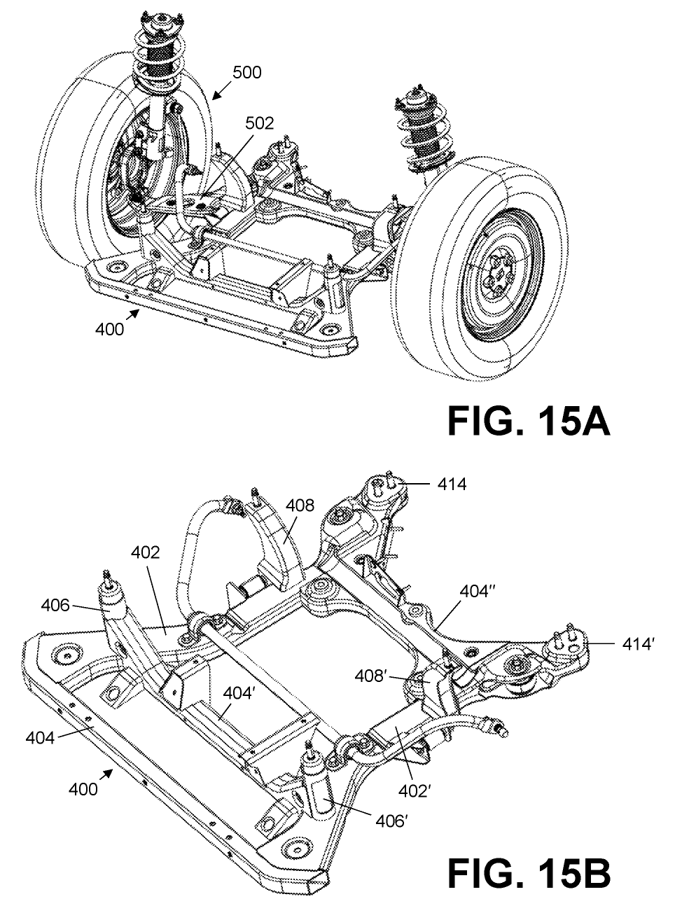

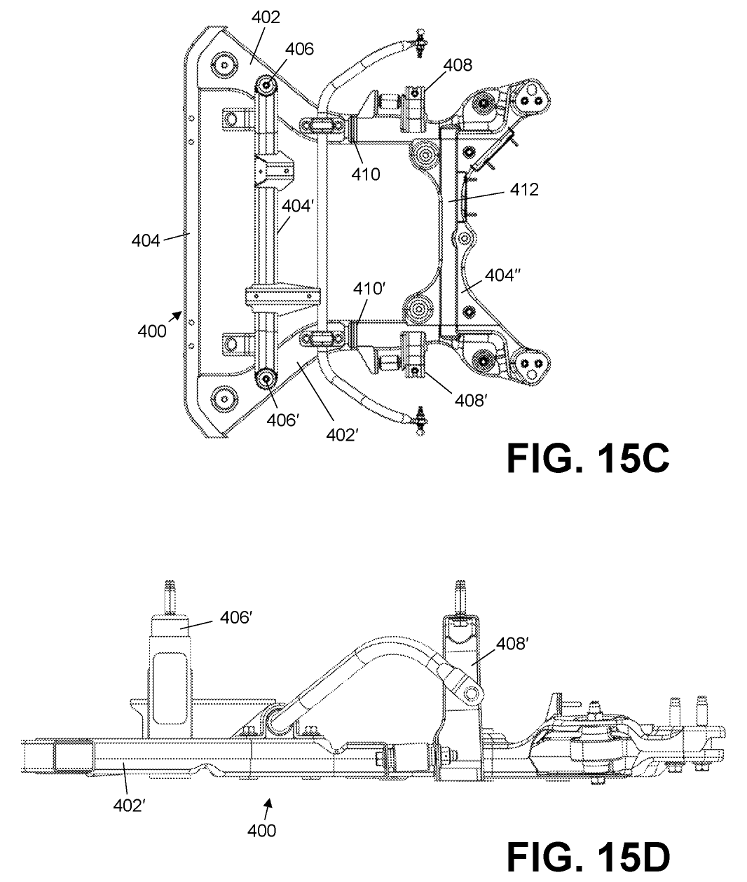

FIGS. 15A - 15D illustrate a cradle 400. As shown in FIG. 15A, the cradle 400 is connected to a suspension assembly 500 by a control arm 502. The cradle 400 is formed of two longitudinal segments 402, 402′ and three crossmembers 404, 404′, 404′′ extending therebetween. The crossmembers 404, 404′, 404′′ translate energy transversely across the cradle 400.

The longitudinal segments 402, 402′ include stress concentrators 410, 410′, and the crossmember 404′′ includes a stress concentrator 412, which provide for a pre-determined deformation, as will be appreciated by the impact sequences discussed and illustrated herein.

The cradle 400 comprises forward attachment members 406, 406′ and rearward attachment members 408, 408′. The forward attachment members 406, 406′ and rearward attachment members 408, 408′ connect the cradle 400 to longitudinal frame rails, such as shown in FIG. 1F. Additionally, the longitudinal segments 402, 402′ are fastened to a floor pan (see FIG. 1F) at their ends 414, 414′.

As will be discussed with respect to the impact sequences described herein, the forward attachment members 406, 406′ and/or the rearward attachment members 408, 408′ may detach from the longitudinal frame rails in cooperation with a pre-determined deformation of the longitudinal frame rails. By such detachment and deformation, energy of a collision may be absorbed.

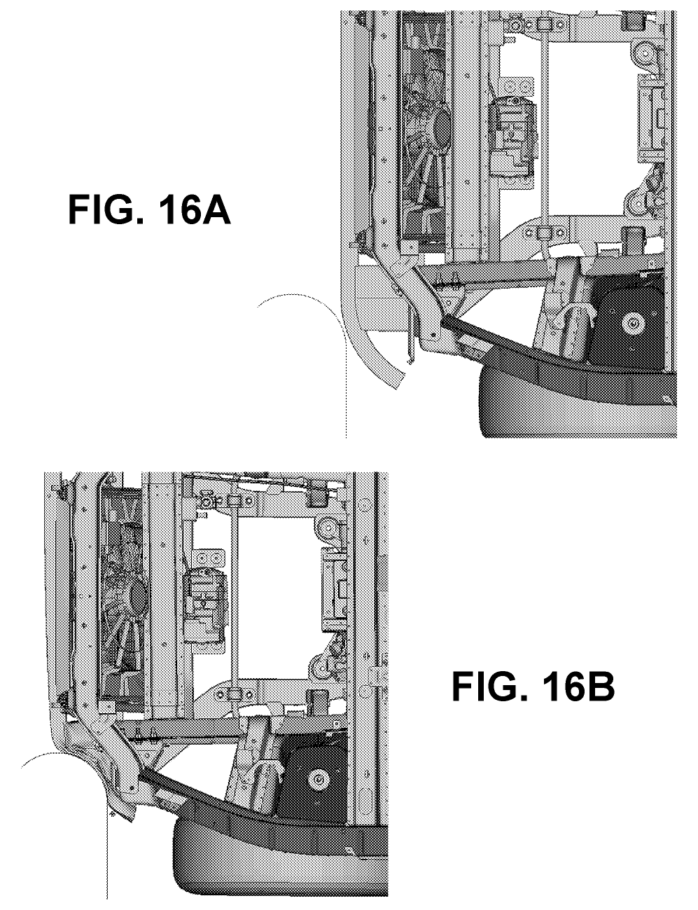

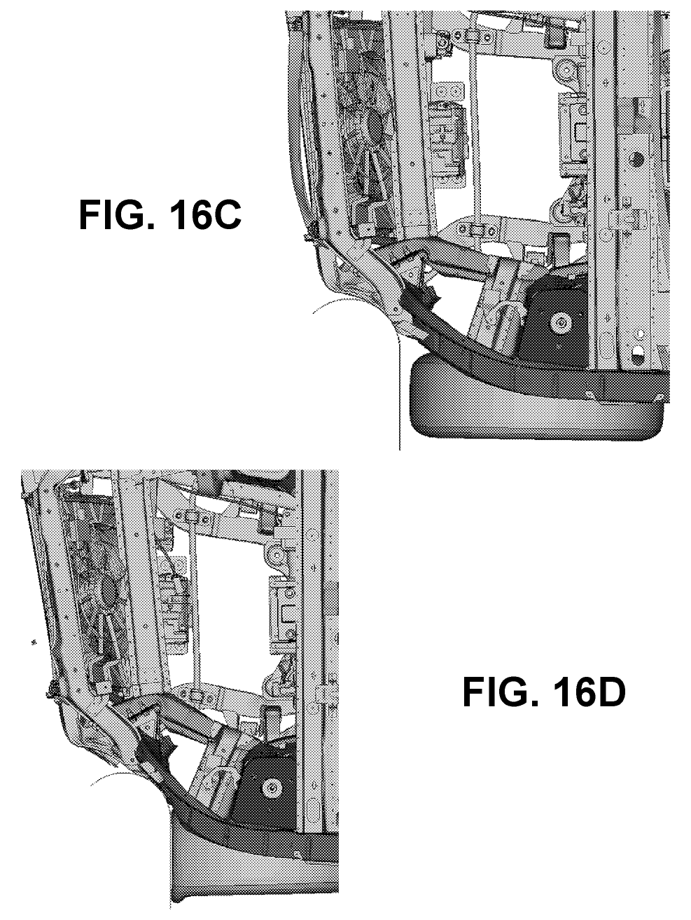

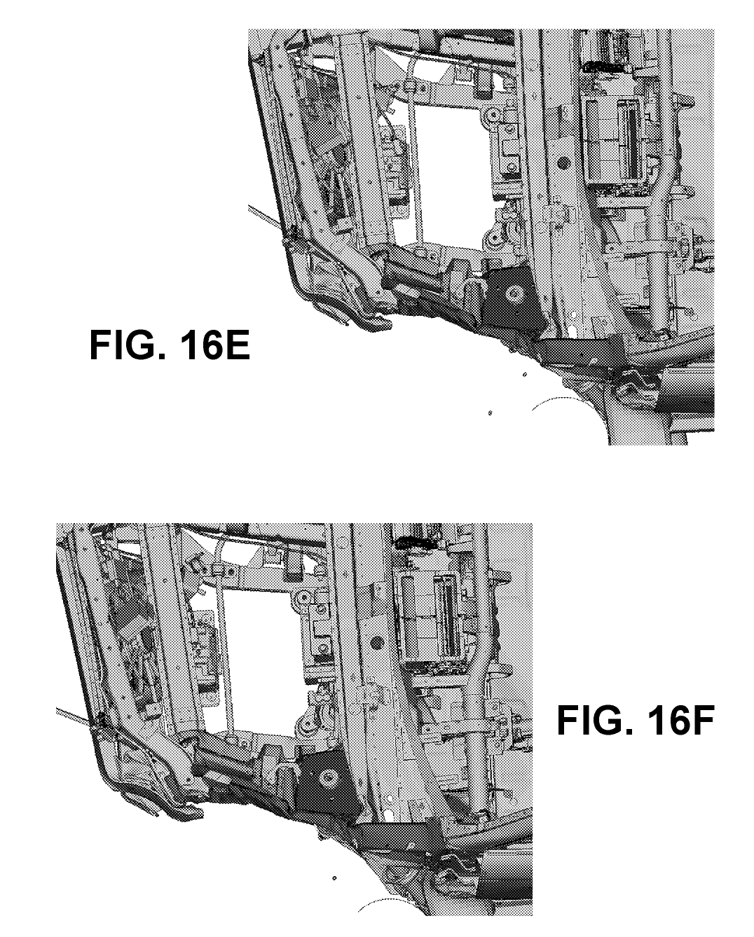

FIGS. 16A - 16F illustrate a sequence of a small-offset frontal overlap impact collision, arranged chronologically respectively at T0 (e.g., 0 milliseconds; FIG. 16A), T1 (e.g., 10 milliseconds; FIG. 16B), T2 (e.g., 20 milliseconds; FIG. 16C), T3 (e.g., 30 milliseconds; FIG. 16D), T4 (e.g., 120 milliseconds; FIG. 16E), and T5 (e.g., 140 milliseconds; FIG. 16F). FIG. 16B shows deformation of the bumper beam and the crush can. FIGS. 16C - 16F shows deformation (i.e., Z-shaped deformation) of the longitudinal frame rail. At the front-most bend, it can be seen that the blocker has pivoted, cooperated in the bending of the longitudinal frame rail, and transferred a force to the crossmember.

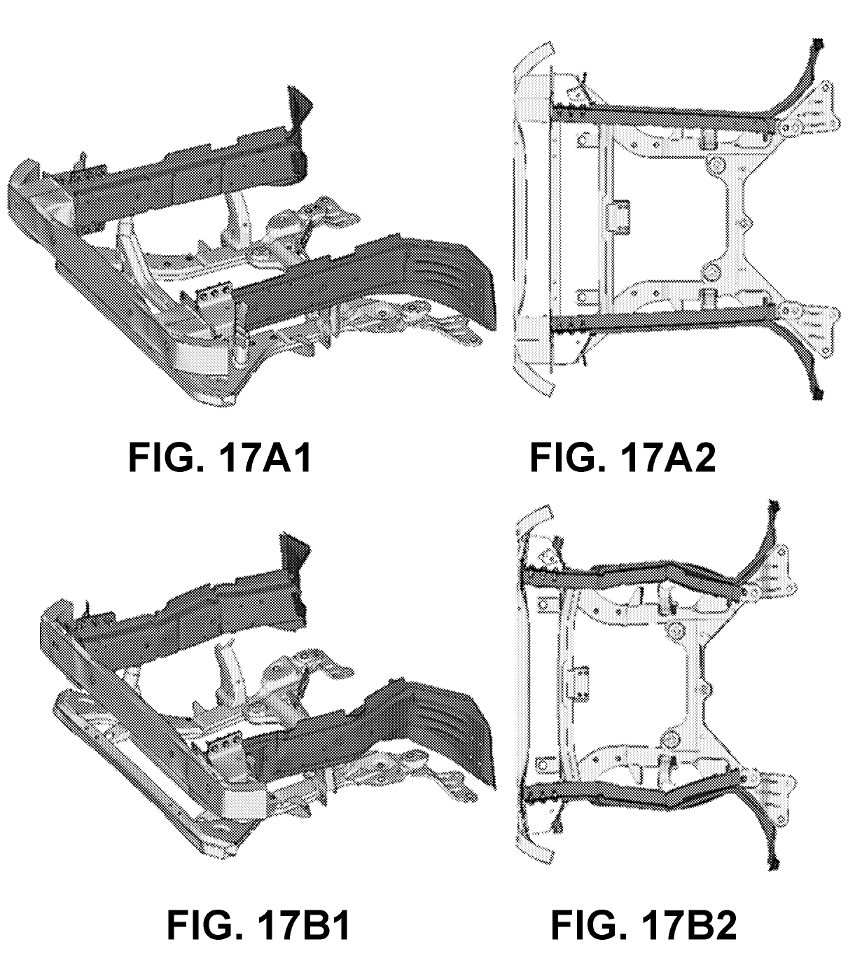

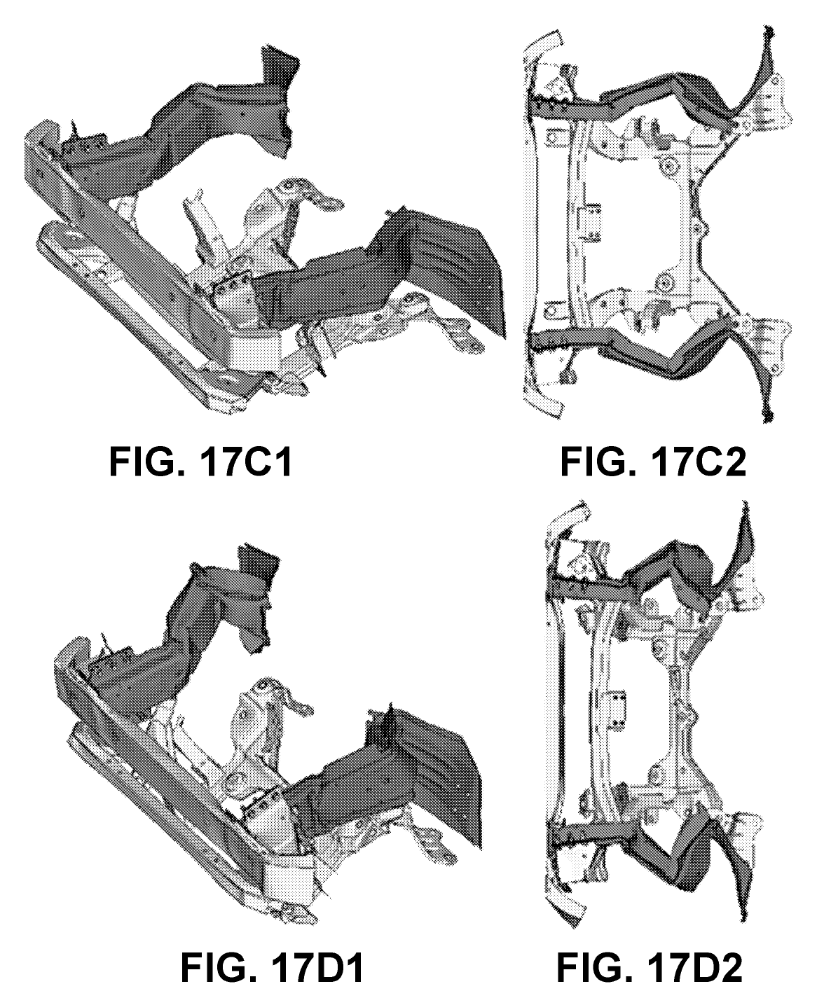

FIGS. 17A1 - 17D2 illustrate a sequence of a full frontal rigid barrier impact collision, arranged chronologically respectively at T0 (FIGS. 17A1 and 17A2), T1 (FIGS. 17B1 and 17B2), T2 (FIGS. 17C1 and 17C2), T3 (FIGS. 17D1 and 17D2). FIGS. 17B1 - 17D2 shows Z-shaped deformation of the longitudinal frame rails and Z-shaped deformation of the cradle. The bends in the longitudinal frame rails are formed generally along first planes and the bends in the cradle are formed generally along second planes, where the second planes are generally orthogonal to the first planes.

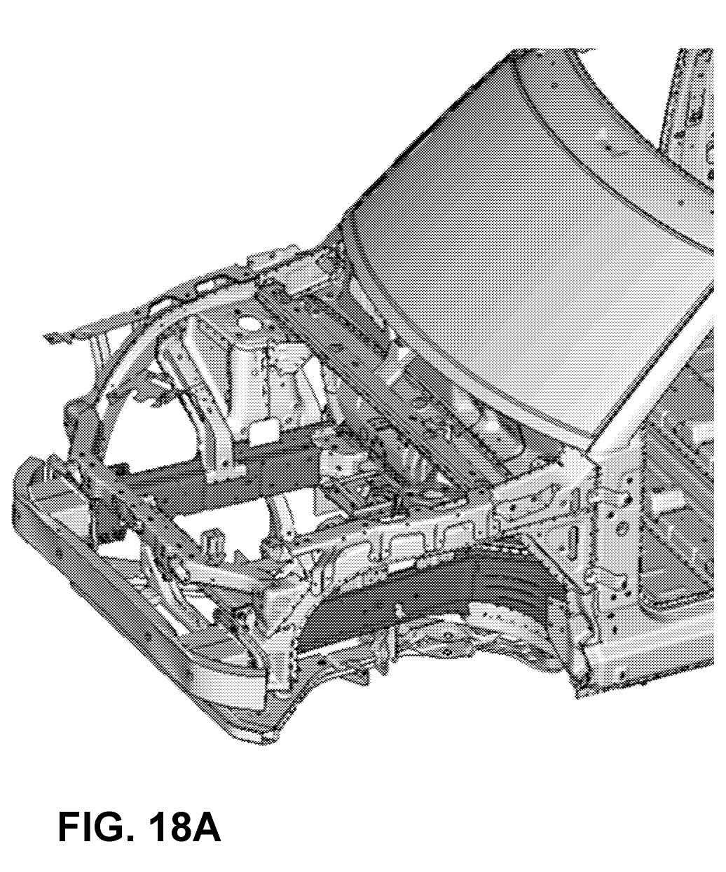

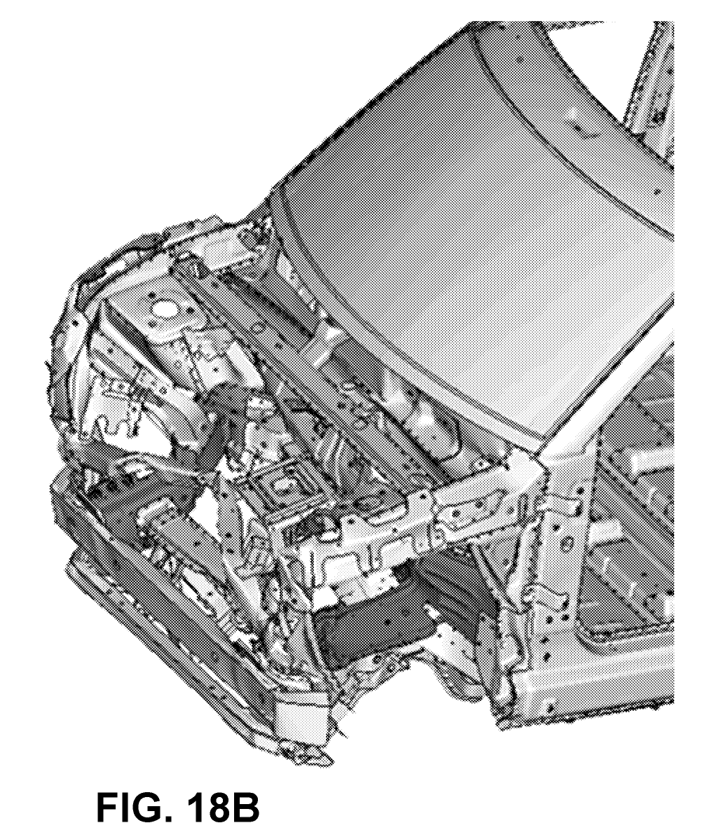

FIGS. 18A and 18B illustrate the other surrounding structure of the vehicle frame at T0 and T3.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements or components identified, and such other elements or components that do not materially affect the basic and novel characteristics of the combination. The use of the terms “comprising” or “including” to describe combinations of elements or components herein also contemplates embodiments that consist essentially of the elements or components.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/- 10⁰ or less, about +/- 5⁰ or less, or even about +/- 1⁰ or less. The terms “generally” or “substantially” to describe angular measurements may mean about +/- 0.01⁰ or greater, about +/- 0.1⁰ or greater, or even about +/- 0.5⁰ or greater.

The terms “generally” or “substantially” to describe linear measurements, percentages, or ratios may mean about +/- 10 % or less, about +/- 5 % or less, or even about +/- 1 % or less. The terms “generally” or “substantially” to describe linear measurements, percentages, or ratios may mean about +/- 0.01 % or greater, about +/- 0.1 % or greater, or even about +/- 0.5 % or greater.

Longitudinal and transverse may be referred to herein with respect to the vehicle frame and/or elements thereof. With respect to the vehicle frame and the vehicle comprising it, a longitudinal axis may extend from a front to a rear of the vehicle frame or vehicle. A central longitudinal axis or centerline may bisect the right and left sides of the vehicle frame or vehicle and extend from a front of the vehicle frame or vehicle to a rear end of the vehicle frame or vehicle. A transverse axis may extend from a left side to a right side of the vehicle frame or vehicle. Thus, the transverse axis may be generally orthogonal to the longitudinal axis. With respect to elements of the vehicle frame, longitudinal may refer to an axis aligned with the largest dimension of an element (e.g., an element’s length), and transverse may refer to an axis generally orthogonal to the longitudinal axis. Longitudinal and transverse may be referred to relative to either an element itself or the overall vehicle frame. By way of example but not limitation, force transferred through a length of a crossmember described herein may transfer along the longitudinal axis of the crossmember and transversely across a vehicle frame.

It is understood by the present teachings that some of the elements of the vehicle frame described herein are present in the vehicle in duplicate and are arranged generally symmetrically relative to the centerline of the vehicle. For example, a first blocker may be located on a left side of the vehicle and a second blocker may be located on a right side of the vehicle. Unless otherwise stated, any function, impact sequence, or otherwise referring to one of these duplicate elements are understood as being attributable to the other of these duplicate elements, unless otherwise explicitly stated or gleaned from the context. For example, in the context of the present teachings, a small-offset frontal overlap impact collision occurs on one side of the vehicle, but it is understood that if the same occurred on the other side of the vehicle the duplicate elements would perform the same or at least substantially the same, given comparable impact conditions. So, where one duplicate element is referred to herein, it will be understood that the disclosure applies to both of the duplicate elements, unless otherwise stated.

It is also contemplated that where reference to “the” or “an” element of the present teachings is made, the same may apply to a corresponding element on the other side of the vehicle.

### REFERENCE NUMERALS

10 vehicle frame

C central longitudinal axis

12 bumper beam

14 crush can

16 blocker

18, 18′ longitudinal frame rail

20 crossmember

22 shock tower reinforcement

24 shotgun

26 hinge pillar

28 A-pillar

30 rocker

32 roof rail

34 B-pillar

36 entry way

38 firewall

40 top segment

42 bottom segment

44 floor pan

46 tunnel

48 seat crossmember

50 tunnel reinforcement

52 floor pan reinforcement

54 bracket

56 insert

58 central portion

60 end portion

62 shock tower

620 shock tower

64a tension brace

64b tension brace

70 outer segment

72 inner segment

74a reinforcement segment

74b reinforcement segment

74c reinforcement segment

80 hinge pillar reinforcement

90 floor box

92 first segment

94 second segment

96 third segment

100 crush can

150 blocker

152 rib

154 flange

200 longitudinal frame rail

202 first segment

204 second segment

206 wing

208 stress concentrator

210 flange

250 shotgun

252 first segment

254 second segment

256 stress concentrator

258 flange

260 flared portion

262 flange

300 shock tower reinforcement

302 flange

350 tension brace

352 first portion

354 second portion

360 tension brace

362 first portion

364 second portion

400 cradle

402, 402′ longitudinal segments

404, 404′, 404′′ crossmembers

406, 406′ forward attachment members

408, 408′ rearward attachment members

410, 410′ stress concentrator

412 stress concentrator

414, 414′ end

500 suspension assembly

502 control arm

What is claimed is:

1. A vehicle frame subassembly for a vehicle for providing a controlled response in a small-offset frontal overlap impact, the vehicle frame subassembly comprising:
a first longitudinal frame rail and a second longitudinal frame rail;
a crossmember extending between and connecting the first and second longitudinal frame rails;
a first blocker and a second blocker respectively connected to the first and second longitudinal frame rails; and
a cradle comprising a first longitudinal segment located proximate to the first longitudinal frame rail, a second longitudinal segment located proximate to the second longitudinal frame rail, and one or more crossmembers extending between the first and second longitudinal segments;
wherein the first and second blockers are generally wedge-shaped and a corner thereof is at least partially juxtaposed with the crossmember, and the first and second blockers function at least in part to direct energy toward a centerline of the vehicle, through the crossmember; and
wherein the cradle is located below the first and second longitudinal frame rails and is connected to the first and second longitudinal frame rails.

2. The vehicle frame subassembly according to claim 1, further comprising a first shock tower reinforcement, a second shock tower reinforcement, a first shotgun, and a second shotgun; wherein the first and second shock tower reinforcements connect, at first ends thereof, to the first and second longitudinal frame rails and, at second ends thereof, to the first and second shotguns; optionally wherein the first and second shock tower reinforcements are respectively welded to the first and second longitudinal frame rails; optionally wherein the first and second longitudinal frame rails are respectively welded to the first and second shotguns; wherein the first and second shock tower reinforcements function to support the first and second shotguns to transfer energy to the first and second shotguns and delay deformation of the first and second shotguns and accordingly aid the vehicle to glide along a barrier.

3. The vehicle frame subassembly according to claim 2, wherein each of the first and second shock tower reinforcements comprise two transversely spaced apart flanges and one or more walls therebetween defining a generally polygonal cross-sectional profile, preferably a generally square or rectangular cross-sectional profile.

4. The vehicle frame subassembly according to claim 3, wherein the first and second shotguns include a plurality of stress concentrators in accordance with one or any combination of the following features: (A) wherein each of the first and second shotguns define a first side (e.g., a top side) and a second side (e.g., a bottom side) that are in opposing relationship to each other; (B) wherein the plurality of stress concentrators are located on the first and second sides; (C) wherein the plurality of stress concentrators on the first side correspond in quantity to the plurality of stress concentrators on the second side, and arranged spatially in pairs; (D) wherein each pair of the plurality of stress concentrators are generally axially aligned; (E) each of the first and second sides include 2 to 10 of the plurality of stress concentrators, more preferably 3 to 8, or even more preferably 4 to 6; or (F) the plurality of stress concentrators extend partially between the first and second sides, preferably on an outboard region of the first and second shotguns.

5. The vehicle frame subassembly according to claim 4, further comprising a bumper beam, a first crush can, and a second crush can; wherein the first and second crush cans are at least partially juxtaposed with the first and second longitudinal frame rails and at least partially juxtaposed with the first and second crush cans.

6. The vehicle frame subassembly according to claim 5, wherein the first and second shotguns are connected at first ends thereof, respectively, to the first and second crush cans, and at second ends thereof, respectively, to hinge pillars; wherein the second ends have generally triangular shapes that flare out to contact the hinge pillars; wherein the first and second shotguns comprise two segments that are fastened together; and wherein seams therebetween extends along lengths of the first and second shotguns.

7. The vehicle frame subassembly according to claim 1, wherein the first and second longitudinal frame rails comprise a plurality of stress concentrators; wherein the plurality of stress concentrators are located on an inboard side of the first and second longitudinal frame rails and/or an outboard side of the first and second longitudinal frame rails; wherein the plurality of stress concentrators include first stress concentrators located on a top corner and/or a bottom corner of the first and second longitudinal frame rails, second stress concentrators that extend between the top and bottom corners, or both..

8. The vehicle frame subassembly according to claim 7, wherein the first and second longitudinal frame rails are oriented at an angle, with respect to the centerline of the vehicle, the angle being about 1 degree to about 15 degrees; and wherein the longitudinal frame rails are at their furthest distance from the centerline at the front-most ends thereof.

9. The vehicle frame subassembly according to claim 8, wherein the crossmember of the longitudinal frame rails includes two opposing ends which are respectfully connected to the first and second longitudinal frame rails.

10. The vehicle frame subassembly according to claim 9, further comprising first and second inserts located respectively within cavities of the first and second longitudinal frame rails; wherein the inserts are generally juxtaposed with the crossmember; and wherein the inserts facilitate energy transfer from the crossmember through opposing sides of the first and second longitudinal frame rails.

11. The vehicle frame subassembly according to claim 10, wherein the first and second longitudinal frame rails comprise two segments that are fastened together (e.g., via pinch welds); wherein seams therebetween extends along lengths of the first and second longitudinal frame rails; and wherein the first and second longitudinal frame rails each include a wing on a rearward end thereof that bends respectively toward corners of hinge pillars, and which is connected to the hinge pillars.

12. The vehicle frame subassembly according to claim 1, wherein subassembly the one or more crossmembers of the cradle include three crossmembers; and wherein one or more of the crossmembers are hourglass shaped.

13. The vehicle frame subassembly according to claim 12, wherein the cradle comprises a first pair of attachment members and a second pair of attachment members; wherein the first and second pair of attachment members connect the cradle to the first and second longitudinal frame rails; and wherein the each of the first and second pairs of attachment members are generally aligned transversely.

14. The vehicle frame subassembly according to claim 1, further comprising a firewall comprising at least a top segment and a bottom segment; and wherein the first and second longitudinal frame rails are connected to the bottom segment.

15. The vehicle frame subassembly according to claim 1, further comprising a first rocker and a second rocker; wherein the first and second rockers include an inner segment, an outer segment, and one or more reinforcement segments that include at least one bend; and wherein the first and second rockers extend to first and second hinge pillars.

16. The vehicle frame subassembly according to claim 1, further comprising one or more first tension braces and one or more second tension braces respectively connecting the first and second longitudinal frame rails, first and second hinge pillars, first and second rockers, or any combination thereof; wherein the first tension braces connect the longitudinal frame rails, the hinge pillars, and the rockers; and wherein the second tension braces connect the first tension braces and the rockers.

17. The vehicle frame subassembly according to claim 1, further comprising first and second hinge pillar reinforcements; wherein the first and second hinge pillar reinforcements locate on inboard sides, respectively, of the first and second hinge pillars.

18. The vehicle frame subassembly according to claim 1, further comprising a floor reinforcement, a tunnel reinforcement, first and second floor boxes, or any combination thereof; wherein the floor reinforcement extends into a region defined between the first and second hinge pillars; wherein the tunnel reinforcement locates over a tunnel in a floor pan; and wherein the first and second floor boxes respectively connect the first and second longitudinal frame rails, first and second rockers, a floor pan, or any combination thereof.

19. The vehicle frame subassembly according to claim 6, wherein cooperation of at least the first or second longitudinal frame rail, the crossmember, the first or second blocker, the first or second shock tower reinforcement, and the first or second shotgun, the cradle, or any combination thereof during the small-offset frontal overlap impact, results in said controlled response and a pre-determined sequence of deformation; wherein the pre-determined sequence of deformation includes:
deformation of the bumper beam and the first or second crush can;
pivoting of the first or second blocker resulting in formation of at least a first bend in the first or second longitudinal frame rail, and a transverse energy transfer imposed upon the crossmember;
transfer of energy transversely through the cradle and deformation thereof;
detachment of one or more attachment members of the cradle from one or both of the first or second longitudinal frame rails;
transfer of energy along a length of the first or second shotgun and deformation of the first or second shotgun, at an end connected to the first or second blocker, toward the centerline of the vehicle;
transfer of energy through the first or second shock tower reinforcement to the first or second shotgun;
a second bend in the first or second longitudinal frame rail, the first and second bends defining a Z-shape in the first or second longitudinal frame rail;
or any combination thereof; and
wherein at least two events in the sequence of deformation occur generally contemporaneously, preferably at least deformation of the first or second longitudinal frame rails and the cradle occur generally contemporaneously.

20. A vehicle comprising the vehicle frame subassembly according to claim 1, wherein the vehicle is an electric vehicle; and wherein the vehicle frame subassembly, upon the small-offset frontal overlap impact, moves the vehicle in a Y-push path, relative to an object the vehicle collides with.
